(19) United States
(12) Patent Application Publication
(10) Pub. No.: US 2025/0247742 A1
(43) Pub. Date: Jul. 31, 2025

(54) COUNTER MECHANISM FOR DISCARDING DATA PACKET SETS

(71) Applicant: Lenovo (Singapore) Pte. Limited, Singapore (SG)

(72) Inventors: Joachim Löhr, Wiesbaden (DE); Razvan-Andrei Stoica, Essen (DE); Hossein Bagheri, Urbana, IL (US); Shwetha Sreejith, Steinbach (DE); Prateek Basu Mallick, Dreieich (DE)

(73) Assignee: Lenovo (Singapore) Pte. Limited, Singapore (SG)

(21) Appl. No.: 19/038,270

(22) Filed: Jan. 27, 2025

Related U.S. Application Data
(60) Provisional application No. 63/626,397, filed on Jan. 29, 2024.

(51) Int. Cl. H04W 28/06; H04L 47/34

(52) U.S. Cl. CPC H04W 28/06; H04L 47/34

(57) ABSTRACT

Various aspects of the present disclosure relate to a counter mechanism for discarding data packet sets. An apparatus, such as a user equipment (UE), receives a data packet associated with a set of data packets for transmission (e.g., a service data unit (SDU) of a packet data convergence protocol (PDCP) protocol data unit (PDU) set). The UE initiates a timer corresponding to reception of the data packet based on receiving the data packet. The UE increments a counter associated with the set of data packets based on a determination that the timer has expired. The UE discards the data packet of the set of data packets based on the counter satisfying a threshold value and a configuration associated with the discarding of the data packet. In some examples, the base station transmits first signaling to the UE that indicates the timer and/or second signaling that indicates the configuration.

### RELATED APPLICATION

This application claims priority to U.S. Provisional Application Ser. No. 63/626,397 filed Jan. 29, 2024, entitled “COUNTER MECHANISM FOR DISCARDING DATA PACKET SETS,” the disclosure of which is incorporated by reference herein in its entirety.

### TECHNICAL FIELD

The present disclosure relates to wireless communications, and more specifically to discarding data packet sets.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive a data packet associated with a set of data packets for transmission, where a timer corresponding to reception of the data packet is initiated based on receiving the data packet, increment a counter associated with the set of data packets based on a determination that the timer has expired, and discard the data packet of the set of data packets based on the counter satisfying a threshold value and a configuration associated with the discarding of the data packet.

A processor (e.g., a standalone processor chipset, or a component of a UE) for wireless communication is described. The processor may be configured to, capable of, or operable to perform one or more operations as described herein. For example, the processor may be configured to, capable of, or operable to receive a data packet associated with a set of data packets for transmission, where a timer corresponding to reception of the data packet is initiated based on receiving the data packet, increment a counter associated with the set of data packets based on a determination that the timer has expired, and discard the data packet of the set of data packets based on the counter satisfying a threshold value and a configuration associated with the discarding of the data packet.

A method performed or performable by a UE for wireless communication is described. The method may include receiving a data packet associated with a set of data packets for transmission, where a timer corresponding to reception of the data packet is initiated based on receiving the data packet, incrementing a counter associated with the set of data packets based on a determination that the timer has expired, and discarding the data packet of the set of data packets based on the counter satisfying a threshold value and a configuration associated with the discarding of the data packet.

In some implementations of the UE, the processor, and the method described herein, the UE, the processor, and the method may further be configured to, capable of, operable to receive signaling indicating the configuration. In some implementations of the UE, the processor, and the method described herein, the signaling includes one or more of information corresponding to the set of data packets or a header with a value of at least one parameter corresponding to the threshold value. In some implementations of the UE, the processor, and the method described herein, the configuration indicates for the UE to discard an entirety of the set of data packets based on the counter satisfying the threshold value, and where the UE discards the entirety of the set of data packets based on the configuration. In some implementations of the UE, the processor, and the method described herein, the UE, the processor, and the method may further be configured to, capable of, operable to transmit, to a base station, signaling that indicates the data packet is discarded. In some implementations of the UE, the processor, and the method described herein, the signaling includes a status report indicating a sequence number (SN) of the data packet and a numerical quantity of subsequent consecutive discarded data packets, and where the data packet is an initial data packet to be discarded from the set of data packets. In some implementations of the UE, the processor, and the method described herein, the UE, the processor, and the method may further be configured to, capable of, operable to transmit first signaling that requests transmission of second signaling that indicates the data packet has been received. In some implementations of the UE, the processor, and the method described herein, the UE, the processor, and the method may further be configured to, capable of, operable to initiate a prohibit timer based on transmitting the signaling, and refrain from transmitting additional signaling that indicates an additional data packet is discarded until expiry of the prohibit timer. In some implementations of the UE, the processor, and the method described herein, the UE, the processor, and the method may further be configured to, capable of, operable to determine that the set of data packets includes one or more redundant data packets based on the threshold value being greater than one. In some implementations of the UE, the processor, and the method described herein, the UE, the processor, and the method may further be configured to, capable of, operable to receive signaling that indicates information corresponding to the set of data packets and determines the threshold value based on the information corresponding to the set of data packets. In some implementations of the UE, the processor, and the method described herein, the information corresponding to the set of data packets includes at least one of a forward error correction (FEC) configuration, higher layers data packetization information, FEC redundancy information within the set of data packets, or a numerical quantity of data packets corresponding to the set of data packets.

In some implementations of the UE, the processor, and the method described herein, the threshold value is unique to the set of data packets. In some implementations of the UE, the processor, and the method described herein, the threshold value corresponds to at least one of a difference between a total numerical quantity of data packets in the set of data packets and a numerical quantity of source data packets in the set of data packets or a numerical quantity of redundant data packets, and where the set of data packets includes one or more source data packets and one or more redundant data packets. In some implementations of the UE, the processor, and the method described herein, the set of data packets includes one or more source data packets and one or more redundant data packets, and where the timer includes at least one of a first duration corresponding to the one or more source data packets or a second duration different from the first duration corresponding to the one or more redundant data packets. In some implementations of the UE, the processor, and the method described herein, the set of data packets includes one or more source data packets and one or more redundant data packets, and where the UE discards the one or more redundant data packets based on the configuration indicating for the UE to discard the one or more redundant data packets. In some implementations of the UE, the processor, and the method described herein, the set of data packets includes one or more source data packets and one or more redundant data packets based on a priority level of the set of data packets. In some implementations of the UE, the processor, and the method described herein, the counter is reset based on receiving an initial data packet associated with the set of data packets. In some implementations of the UE, the processor, and the method described herein, the data packet includes a service data unit (SDU) received from an upper layer of a protocol stack, and where the set of data packets include a packet data convergence protocol (PDCP) protocol data unit (PDU) set. Additionally, or alternatively, the timer includes a PDCP discard timer.

An NE (e.g., a base station) for wireless communication is described. The NE may be configured to, capable of, or operable to perform one or more operations as described herein. For example, the NE may be configured to, capable of, or operable to transmit, to a UE, first signaling that indicates a timer associated with respective data packets in a set of data packets for transmission by the UE, and transmit, to the UE, second signaling that indicates a configuration associated with discarding a data packet of the set of data packets based on a counter satisfying a threshold value.

A processor (e.g., a standalone processor chipset, or a component of a UE) for wireless communication is described. The processor may be configured to, capable of, or operable to perform one or more operations as described herein. For example, the processor may be configured to, capable of, or operable to transmit, to a UE, first signaling that indicates a timer associated with respective data packets in a set of data packets for transmission by the UE, and transmit, to the UE, second signaling that indicates a configuration associated with discarding a data packet of the set of data packets based on a counter satisfying a threshold value.

A method performed or performable by an NE (e.g., a base station) for wireless communication is described. The method may include transmitting, to a UE, first signaling that indicates a timer associated with respective data packets in a set of data packets for transmission by the UE, and transmitting, to the UE, second signaling that indicates a configuration associated with discarding a data packet of the set of data packets based on a counter satisfying a threshold value.

In some implementations of the NE, the processor, and the method described herein, the configuration indicates for the UE to discard an entirety of the set of data packets based on the counter satisfying the threshold value. In some implementations of the NE, the processor, and the method described herein, the first signaling indicates at least one of information corresponding to the set of data packets or a header with a value of at least one parameter corresponding to the threshold value. In some implementations of the NE, the processor, and the method described herein, the information corresponding to the set of data packets includes at least one of a FEC configuration, higher layers data packetization information, FEC redundancy information within the set of data packets, or a numerical quantity of data packets corresponding to the set of data packets. In some implementations of the NE, the processor, and the method described herein, the NE, the processor, and the method may further be configured to, capable of, operable to receive, from the UE, third signaling that indicates the data packet is discarded. In some implementations of the NE, the processor, and the method described herein, the third signaling includes a status report indicating an SN of the data packet and a numerical quantity of subsequent consecutive discarded data packets, and where the data packet is an initial data packet to be discarded from the set of data packets. In some implementations of the NE, the processor, and the method described herein, the NE, the processor, and the method may further be configured to, capable of, operable to receive, from the UE, third signaling that requests transmission of fourth signaling that indicates the data packet has been received. In some implementations of the NE, the processor, and the method described herein, the NE, the processor, and the method may further be configured to, capable of, operable to select a value greater than one for the threshold value based on the set of data packets including one or more redundant data packets. In some implementations of the NE, the processor, and the method described herein, the NE, the processor, and the method may further be configured to, capable of, operable to select a value equal to one for the threshold value based on the set of data packets failing to include one or more redundant data packets.

In some implementations of the NE, the processor, and the method described herein, the threshold value is unique to the set of data packets. In some implementations of the NE, the processor, and the method described herein, the threshold value corresponds to at least one of a difference between a total numerical quantity of data packets in the set of data packets and a numerical quantity of source data packets in the set of data packets or a numerical quantity of redundant data packets, and where the set of data packets includes one or more source data packets and one or more redundant data packets. In some implementations of the NE, the processor, and the method described herein, the set of data packets includes one or more source data packets and one or more redundant data packets, and where the timer includes at least one of a first duration corresponding to the one or more source data packets or a second duration different from the first duration corresponding to the one or more redundant data packets. In some implementations of the NE, the processor, and the method described herein, the set of data packets includes one or more source data packets and one or more redundant data packets, and where the configuration indicates for the UE to discard the one or more redundant data packets. In some implementations of the NE, the processor, and the method described herein, the set of data packets includes one or more source data packets, and one or more redundant data packets based on a priority level of the set of data packets. In some implementations of the NE, the processor, and the method described herein, the data packet includes an SDU received from an upper layer of a protocol stack, and where the set of data packets include a PDCP PDU set. In some implementations of the NE, the processor, and the method described herein, the timer includes a PDCP discard timer.

### BRIEF DESCRIPTION OF THE DRAWINGS

FIG. 1 illustrates an example of a wireless communications system in accordance with aspects of the present disclosure.

FIG. 2 illustrates an example of a data packet set mapping diagram, in accordance with aspects of the present disclosure.

FIG. 3 illustrates an example of a protocol stack diagram, in accordance with aspects of the present disclosure.

FIGS. 4 and 5 illustrate examples of transmission diagrams, in accordance with aspects of the present disclosure.

FIGS. 6 and 7 illustrate examples of signaling diagrams, in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a network equipment (NE) in accordance with aspects of the present disclosure.

FIG. 11 illustrates a flowchart of a method performed by a UE in accordance with aspects of the present disclosure.

FIG. 12 illustrates a flowchart of a method performed by an NE in accordance with aspects of the present disclosure.

### DETAILED DESCRIPTION

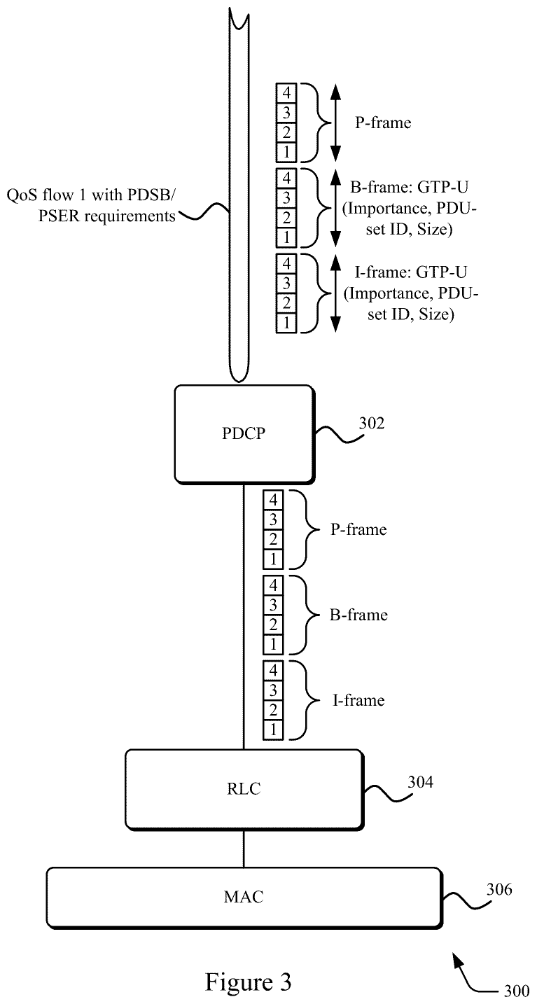

A wireless communications system may include one or more wireless devices, including NEs (e.g., base stations) and UEs. The wireless devices may support extended reality (XR) data traffic, where XR includes virtual reality (VR), augmented reality (AR), and mixed reality (MR). The XR data traffic may include video data and may be divided into sets of data units for transmission by a wireless device (e.g., a UE for an uplink transmission or an NE for a downlink transmission). In some examples, the data packet may be received at several layers of a protocol stack prior to transmission. For example, the wireless device may receive an instance of the data packet from an upper layer, or higher layer, of the protocol stack, where the instance of the data unit may be referred to as an SDU. Examples of upper layers of the protocol stack include, but are not limited to, a PDCP layer and a radio resource control (RRC) layer, which is described in further detail with respect to FIG. 3. The instances of data packets received from the upper layer are concatenated to form a set of data packets for transmission, where the set may be referred to as a PDU set (e.g., a PDCP PDU set).

In some examples, the wireless devices may perform error control for a data transmission. For example, the wireless devices may implement FEC, in which a transmitting device introduces redundant data in advance with source data. The redundant data may enable a receiving device to recover from different data packet losses of the source data. The wireless device may perform application layer (AL)-FEC at an AL to enhance the error resiliency of the data, including for XR data traffic.

In some examples, an NE may enable discarding operations at a UE that enables the UE to discard one or more data packets stored at different layers for transmission. For example, the UE may determine whether one or more conditions are satisfied for discarding SDUs for an uplink transmission. The NE may configure the conditions, and the conditions may include a timer (e.g., PDCP discard timer) and/or reception of feedback from the NE confirming successful reception and decoding of the uplink transmission. The UE may start or initiate a timer for a data packet in a set of data packets upon reception of the data packet from upper layers. If the timer expires, then the UE may determine the data packet of the set is lost and may discard the entire set of data packets. However, if the uplink transmission includes one or more redundant data packets and/or repair data packets (e.g., for AL-FEC techniques), then the UE discarding an entire set of data packets due to a loss of one or more data packets of the set may result in inefficient use of processing resources. That is, if the set of data packets includes redundant data packets and/or repair data packets, then a receiving device (e.g., the NE) may be able to decode the set of data packets using the redundant data and/or repair data included in the set of data packets even if one or more of the data packets are lost. Thus, discarding the entire set of data packets due to one or more lost data packets may be unnecessary.

As described herein, to reduce or eliminate processing inefficiencies due to unnecessary discard of sets of data packets, a UE may implement a counter mechanism. For example, the UE may receive a data packet (e.g., an SDU) from an upper layer of a protocol stack and may initiate a timer if discarding techniques are enabled at the UE. The timer may be a PDCP discard timer, which may be configured and/or enabled by a NE. If the timer expires for the received data packet, then the UE may increment a counter for a set of data packets that includes the received data packet. In some examples, the UE may reset the counter (e.g., to zero) upon reception of a first or initial data packet in the set of data packets from the upper layer. The UE may discard a portion of data packets in the set of data packets or the entirety of the set of data packets if the value of the counter satisfies a threshold value and according to a configuration. For example, the UE may receive signaling indicating the configuration, where the configuration indicates for the UE to discard an entirety of the data packets in the set of data packets when the counter satisfies the threshold value. Additionally, or alternatively, the signaling indicating the configuration may explicitly or implicitly indicate the threshold value.

Aspects of the present disclosure are described in the context of a wireless communications system.

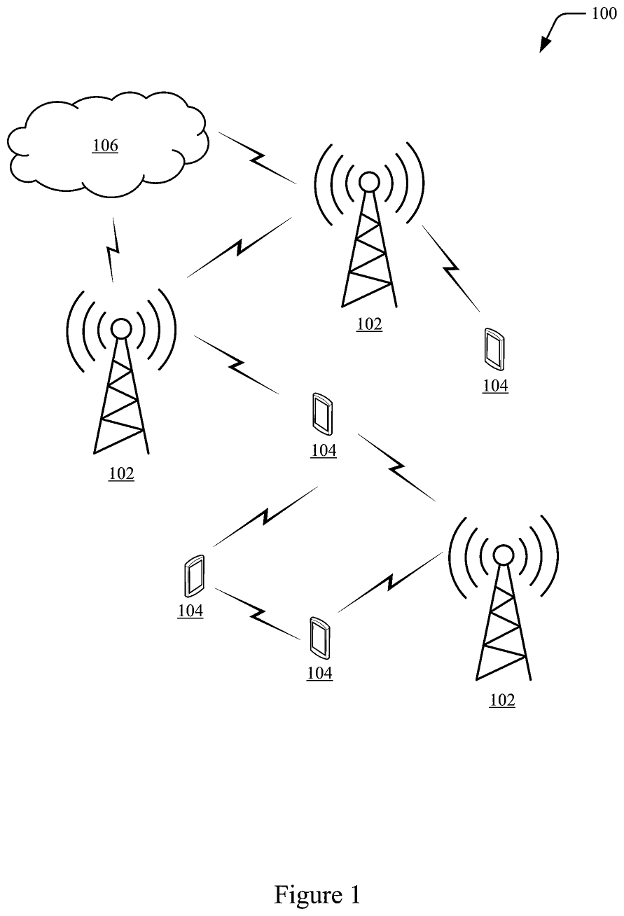

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, one or more wireless devices in the wireless communications system 100 may exchange XR data traffic. XR data traffic may include data traffic for different types of realities including VR, AR, and MR. In some cases, a VR experience may include a rendered version of a delivered visual and audio scene. The rendering is designed to mimic the visual and audio sensory stimuli of the real world as naturally as possible to an observer or user as they move within the limits defined by an application. In variations, for a VR experience, a user may wear a head mounted display (HMD), to replace a field of view with a simulated visual component and may wear headphones to provide the user with accompanying audio. Some form of head and motion tracking of the user in VR provides the simulated visual and audio components to be updated in order to ensure that, from the user's perspective, items and sound sources remain consistent with the user's movements. Additional, or alternative, means to interact with the VR simulation may be provided.

In some examples, such as for AR experiences, a user is provided with additional information or artificially generated items, or content overlaid upon a current environment. Such additional information or content may be visual and/or audible and the observation of a current environment may be direct, with no intermediate sensing, processing, and rendering, or indirect, where a perception of the environment is relayed via sensors and may be enhanced or processed. An MR experience may be an advanced form of an AR experience, where some virtual elements are inserted into the physical scene with the intent to provide the illusion that these elements are part of the real scene. An XR experience refers to real and virtual combined environments and human-machine interactions generated by computer technology and wearables. XR includes representative forms such as AR, MR and VR and the areas interpolated among them. The levels of virtuality range from partial sensory inputs to fully immersive VR. A key aspect of XR is the extension of human experiences especially relating to the senses of existence (e.g., represented by VR) and the acquisition of cognition (e.g., represented by AR). Many XR and configured grant (CG) use cases are characterized by quasi-periodic traffic with possible jitter and relatively high data rate in the downlink signaling (e.g., a data rate that satisfies a threshold value, a video steam) combined with frequent uplink signaling (e.g., pose and/or control update) and/or an uplink video stream. Both downlink and uplink traffic are also characterized by relatively strict packet delay budget (PDB) (e.g., relatively small PDB, less than a threshold value).

The set of anticipated XR and CG services has a variety and characteristics of the data streams (e.g., video) that may change “on-the-fly,” while the services are running on a network (e.g., an NR network). Therefore, additional information on the running services from higher layers, (e.g., the QoS flow association, frame-level QoS, PDU set-based QoS, XR specific QoS etc.) may be beneficial to facilitate informed choices of radio parameters. In some cases, XR application awareness by a UE 104 and an NE 102 may improve user experience, may improve a capacity of the wireless communications system 100 for XR services, and/or may reduce power consumption of a UE 104.

An application data unit (ADU) or PDU set is the smallest unit of data that can be processed independently by an application, such as processing for handling out-of-order traffic data. A video frame can include one or more different types of frames, where a video frame represents a point in time and includes visual information that contributes to an overall video (e.g., position, color, intensity, etc., of an image). Example types of frames may include, but are not limited to, an intraframe (I-frame), predicted frame (P-frame), and a bi-directional frame (B-frame). In some examples, an I-frame are independent frames that do not rely on other frames for decoding. That is, an I-frame may include a set of information for displaying a frame. I-frames are relatively large compared with other types of frames, causing a relatively high use of time-frequency resources for transmission, but may contribute to a better image quality. In variations, a P-frame may rely on previous I-frames and/or P-frames for reconstruction and may store changes (e.g., motion vectors) from a previous frame to reduce a size of the P-frame. A B-frame may use information from both previous and future frames to reduce a size of the frame for transmission.

In some cases, a video frame can be composed of an I-frame or a P-frame, and/or can be composed of I-slices and/or P-slices. Additionally, or alternatively, a data packet set (e.g., a PDU set) may include one or more I-slices, P-slices, I-frame, P-frame, or any combination thereof. A PDU set may include one or more PDUs carrying a payload of one unit of information generated at the application level (e.g., frame(s) or video slice(s) for XR services).

In some examples, a UE 104 and/or an NE 102 may implement a service-oriented design that accounts for characteristics of XR data traffic to enable more efficient delivery of XR data traffic. The characteristics may include one or more of a variable data packet arrival rate (e.g., packets coming at 30-120 frames per second (fps) with some jitter), data packets having variable and relatively large packet size (e.g., greater than a threshold value), B-frames and/or P-frames being dependent on I-frames, presence of multiple traffic and/or data flows (e.g., pose and video scene in uplink). In some examples, the efficient delivery of the XR data traffic may be due to the XR data traffic satisfying one or more XR service criteria for a greater numerical quantity of UEs 104 and/or reducing power consumption for one or more UEs 104.

In some examples, a latency criteria of XR traffic for a RAN (e.g., air interface) may be modelled as PDB. The PDB is a time budget and/or threshold duration for a data packet to be transmitted over the air from an NE 102 to a UE 104. For a given packet, the delay of the packet incurred at an air interface is measured from the time that the data packet arrives at the NE 102 to the time that the data packet is successfully transferred to the UE 104. In some examples, if the delay is larger than a configured or defined PDB for the data packet, then the data packet violates (e.g., fails to satisfy) a PDB. In some other examples, if the delay is less than or equal to a configured or defined PDB for the data packet, then the data packet is successfully delivered (e.g., satisfies) a PDB. The value of a PDB for a data packet may vary for different applications and data traffic types, which can be 10-20 milliseconds (ms) depending on the application. In some cases, a 5G arrival time of data bursts for downlink transmission can be quasi periodic (e.g., periodic with jitter). Some of the factors leading to jitter in burst arrival include, but are not limited to, varying server render time, encoder time, real-time transport protocol (RTP) packetization time, and a link between a server and a 5G gateway, among others. In one or more implementations, an NE 102 and/or a UE 104 may calculate an estimated downlink traffic arrival jitter using one or more algorithms and/or models. For example, the NE 102 and/or the UE 104 may use a truncated Gaussian distribution (e.g., with a mean of 0 ms, a standard deviation of 2 ms, a range of [−4 ms, 4 ms](baseline), [−5 ms, 5 ms]).

In some examples, applications can have a delay criteria for a PDU set that may not be adequately translated into a PDB value. For example, if the PDU set delay budget (PSDB) is 10 ms, then the PDB can be set to 10 ms if the entirety of the PDU set (e.g., all data packets of the PDU set) arrive at the same time. In some cases, such as if data packets of a data packet set are spread out in the time domain, then the PSDB is measured either in terms of the arrival of a first data packet of the PDU set or the last data packet of the PDU set. In either case, a PSDB may result in different PDB criteria for a different packets of the PDU set. A PSDB may be an upper bound for a duration between a reception time of a first PDU (e.g., at the UPF for downlink, at a UE 104 for uplink) and the time when all PDUs of a PDU set have been successfully received (e.g., at the UE in downlink, at the UPF in uplink).

With respect to delay-aware communication, if one or both of a scheduler or the UE 104 is aware of one or more delay budgets for a data packet and/or ADU, then the NE 102 can take this information into account in scheduling transmissions (e.g., by giving priority to transmissions close to their delay budget limit, and by not scheduling uplink transmissions). Additionally, or alternatively, the UE 104 can take advantage of the information to determine if an uplink transmission (e.g., physical uplink control channel (PUCCH) in response to a physical downlink shared channel (PDSCH), uplink pose, or physical uplink shared channel (PUSCH)) corresponding to a transmission that exceeds a respective delay budget can be dropped. Further, the UE 104 may determine not to monitor for a retransmission of a downlink transmission (e.g., a PDSCH transmission) and may discard an erroneously received downlink transmission from a buffer during soft combining with a retransmission that never occurs. The UE 104 may determine how much of a channel occupancy time to share with an NE 102 when using unlicensed spectrum for a transmission. In some examples, a remaining delay budget for a downlink transmission can be indicated to the UE 104 via various signaling, such as in a downlink control information (DCI) message (e.g., for a packet of a video frame, slice, and/or ADU) or via a medium access control-control element (MAC-CE) (e.g., for a video frame, slice, and/or ADU). Additionally, or alternatively, a remaining delay budget for an uplink transmission can be indicated to the NE 102 via an uplink transmission of various signaling, such as uplink control information (UCI), a PUSCH transmission, or the like.

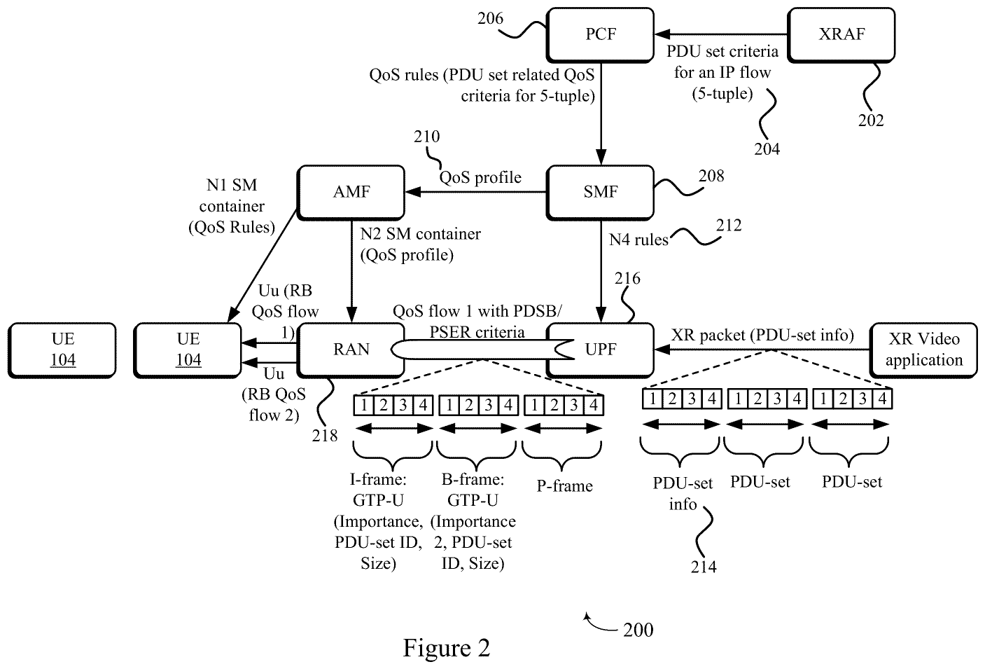

With respect to XR services, the support of XR services may result in relatively high data rate and low latency communications. XR awareness relies on QoS flows, PDU sets, data bursts, and traffic assistance information, which is described in further detail with respect to FIG. 2. In some examples, QoS refers to a measurement of performance characteristics of a network experienced by wireless devices within the network and may include, but is not limited to, a reliability, an availability, a latency, a throughput, and a prioritization of data traffic. In variations, a QoS flow represents a lowest level of granularity for flow of data traffic. Respective QoS flows may have different unique identifiers, referred to as QoS flow identifiers (QFIs), and parameters that describe the characteristics of the flow of data packets.

Traffic assistance information may be provided by a 5GC to the NE 102 via time-sensitive communications (TSC) assistance information (TSCAI) (e.g., for both guaranteed flow bit rate (GBR) and non-GBR QoS flows), uplink and/or downlink periodicity, N6 Jitter Information (e.g., between a UPF and a data network) associated with the downlink periodicity, an indication of an end of a data burst in a general packet radio service (GPRS) tunneling protocol-user plane (GTP-U) header of a last PDU in a downlink transmission. In the uplink, a UE 104 identifies PDU sets and data bursts dynamically, including an importance level of a PDU set (PSI). With respect to jitter aspects of XR data traffic, a packet arrival rate is determined by a frame generation rate (e.g., 60 fps). Accordingly, the average packet arrival periodicity is given by the inverse of the frame rate (e.g., 16.6667 ms= 1/60 fps). The periodic arrival without jitter gives the arrival time at gNB for packet with index k (=1, 2, 3 . . . ) as

$$\frac{k}{F} \times 1000 ms ,$$

where F is a given frame generation rates per second. Note that a periodic packet arrival implicitly assumes fixed delay contributed from the network side, including fixed video encoding time, fixed network transfer delay, etc.

However, the varying frame encoding delay and network transfer time introduces jitter in packet arrival time at the NE 102. The jitter can be modeled as a random variable with periodic arrivals. The jitter follows a truncated Gaussian distribution with following statistical parameters, shown in Table 1.

TABLE 1
Statistical parameters for jitter

| | | Baseline value for | Optional value for |
|---|---|---|---|
| Parameter | unit | evaluation | evaluation |
| Mean | ms | 0 | |
| STD | ms | 2 | |
| Truncation range | ms | [−4, 4] | [−5, 5] |

A configured or defined parameter value and frame generation rates (e.g., 60 or 120) ensure that packet arrivals are in order (e.g., arrival time of a next packet is always larger than that of the previous packet). Thus, the periodic arrival with jitter gives the arrival time for packet with index k (=1, 2, 3 . . . ) as

$$offset + \frac{k}{F} \times 1000 + J ( ms ) ,$$

where F is a configured or defined frame generation rate per second and J is a random variable capturing jitter. An actual traffic arrival time of data traffic for respective UEs 104 could be shifted by a UE-specific arbitrary offset.

In one or more implementations, as described for delay aware communications, the NE 102 and the UE 104 may implement delay status reporting (DSR), in which an NE 102 can take knowledge of a PDU set delay into account when scheduling transmissions (e.g., by giving priority to transmissions close to their delay budget limit, and by not scheduling uplink transmissions exceeding a PDSB). The UE 104 can also take advantage of such knowledge to reduce power consumption by determining if an uplink transmission (e.g., uplink pose, or physical uplink shared channel (PUSCH)) corresponding to a transmission that exceeds its delay budget can be dropped. Additionally, or alternatively, the UE 104 may not wait for a retransmission of a PDSCH that may not occur (e.g., discontinuous reception (DRX) retransmission timers can be stopped). For downlink transmissions, the NE 102 may be aware of the remaining delay budget of data pending for transmission (e.g., based on information provided by a session management function (SMF)), and takes such knowledge into account in scheduling decisions.

For uplink resource allocation, the UE 104 provides some assistance information regarding a remaining delay budget of the data pending in a buffer of the UE 104 to the NE 102. The UE 104 provides information on the remaining delay budget of the data for which uplink resources are requested. Such assistance information is referred to as DSR reporting. The PSDB information provided to the RAN is not sufficient. Since the NE 102 is not aware of the exact arrival time of uplink data in the buffer and hence can also not be sure about the remaining (e.g., valid) time of data being pending in the buffer for transmission, the UE 104 provides this information (e.g., remaining delay information) within the DSR. In one or more implementations, a DSR MAC-CE is introduced for XR-specific logical channel groups (LCGs), which includes the amount of data available for transmission and some remaining delay information associated with the data reported. That is, an NE 102 and/or a UE 104 may define control signaling (e.g., a MAC-CE) for DSR. Furthermore, threshold based DSR reporting is supported (e.g., DSR reporting is triggered when remaining delay of a PDU or PDU set is below an NE 102 configured threshold). The threshold is configured per LCG. Configuring multiple thresholds for a LCG may also be supported.

In some examples, a UE 104 may receive a data packet of a PDU set for an uplink transmission at several layers of a protocol stack prior to transmission of the data packet and/or the PDU set. For example, the UE 104 may receive an SDU from an upper layer, or higher layer, of the protocol stack. In variations, the UE 104 may store the SDU and/or one or more other instances of data packets of the PDU set at a buffer. However, the buffer may become congested, resulting in communication delays and/or inefficient use of memory resources at the UE 104. Thus, the NE 102 may implement PDU set discard mechanisms at the UE 104 for data packets of an uplink transmission. The PDU set discard mechanisms may include configuration of a timer, referred to as a PDCP discard timer, at the UE 104. For example, the NE 102 may transmit control signaling (e.g., a DCI message, a MAC-CE, and/or RRC signaling) to the UE 104 that includes an indication of a duration of a timer for one or more data packets of a data packet set (e.g., a PDU set). The UE 104 may initiate the timer upon receiving a data packet from an upper layer of a protocol stack and/or upon submitting the data packet to a lower layer of the protocol stack for transmission. If the timer expires prior to transmitting the data packet, then the UE 104 may discard the PDU set.

In some examples, an NE 102 and/or a UE 104 may enable PSI-based discarding for PDU set discarding in the presence of uplink congestion. Therefore, in addition to the timer-based discard mechanism within a given PDCP entity, a PDCP discarding mechanism based on PSI is introduced for XR communications. In some cases, an NE 102 may configure the PSI-based discarding at the UE 104 at the presence of congestion. For example, the NE 102 may transmit signaling that indicates (e.g., explicitly) for the UE 104 to enable or disable PSI-based PDCP discarding. Thus, the NE 102 may enable or disable PSI-based discarding based on a detected congestion. In one or more implementations, the NE 102 indicates to the UE 104 to apply a PSI-based XR discard mechanism via dedicated signaling (e.g., a MAC-CE, a DCI message, and/or RRC signaling for enabling or disabling the PSI-based discard mechanism).

The configuration enabling or disabling PSI-based discarding may include a timer-based technique or a threshold-based technique. If the NE 102 determines there is congestion and determines to use PSI-based discarding, then the NE 102 indicates to the UE 104 to apply PSI-based discarding via dedicated signaling. For a timer-based technique, the NE 102 indicates for the UE 104 to set a new discard timer value (e.g., a congestion timer value) for different PSI levels of a data packet. For a threshold-based technique, the NE 102 indicates for the UE 104 to drop PDU sets with PSI levels that fail to satisfy (e.g., are less than) a threshold value. The UE 104 may drop the PDU sets as soon as they enter the buffer or upon activation of PSI-based discarding at the UE 104.

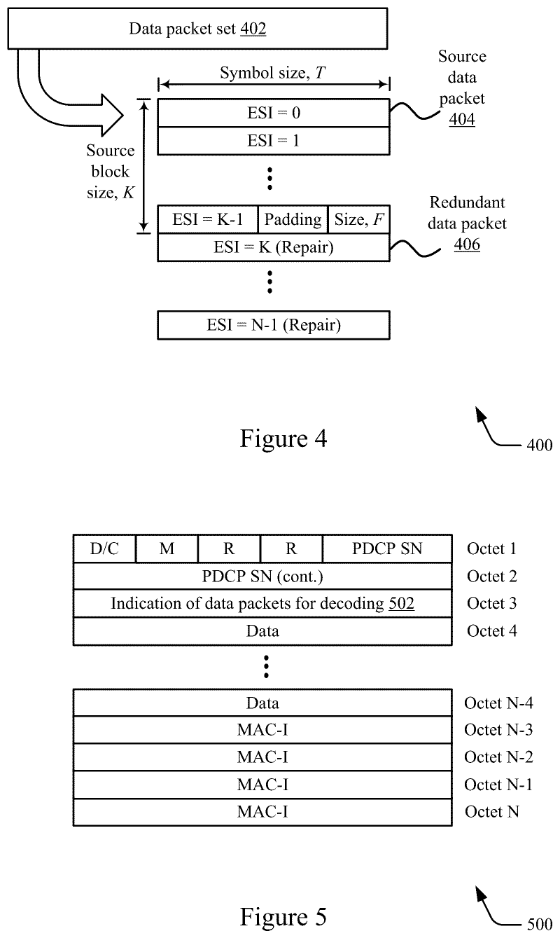

In some examples, a UE 104 may perform error control for a data transmission. For example, the UE 104 may implement FEC for an uplink transmission by including redundant data in advance with source data. The redundant data may enable a receiving device to recover from different data packet losses of the source data. The UE 104 may perform AL-FEC at an AL to enhance the error resiliency of the data, including for XR data traffic, which is described in further detail with respect to FIG. 4. However, if the UE 104 is implementing PDU set discard techniques and the uplink transmission includes one or more redundant data packets and/or repair data packets (e.g., for AL-FEC techniques), then the UE 104 discarding an entire PDU set due to a loss of one or more data packets of the PDU set may result in inefficient use of processing resources, as well as transmission delays at the UE 104.

In some examples, to reduce or eliminate processing inefficiencies and the loss of PDU sets due to unnecessary discard of sets of data packets, a UE 104 may implement a counter mechanism. For example, the UE 104 may receive a data packet (e.g., an SDU) from an upper layer of a protocol stack and may initiate a timer if discarding techniques are enabled at the UE 104. The timer may be a PDCP discard timer, which may be configured and/or enabled by an NE 102. If the timer expires for the received data packet, then the UE 104 may increment a counter for a set of data packets that includes the received data packet. In some examples, the UE 104 may reset the counter (e.g., to zero) upon reception of a first or initial data packet in the set of data packets from the upper layer. The UE 104 may discard a portion of data packets in the set of data packets or the entirety of the set of data packets if the value of the counter satisfies a threshold value and according to a configuration. For example, the UE 104 may receive signaling indicating the configuration, where the configuration indicates for the UE 104 to discard an entirety of the data packets in the set of data packets when the counter satisfies the threshold value. Additionally, or alternatively, the signaling indicating the configuration may explicitly or implicitly indicate the threshold value.

FIG. 2 illustrates an example of a data packet set mapping diagram 200 in accordance with aspects of the present disclosure. In some examples, the data packet set mapping diagram 200 implements aspects of the wireless communications system 100. For example, the data packet set mapping diagram 200 may include a UE 104, which may be an example of a UE 104 as described with reference to FIG. 1. The data packet set mapping diagram 200 illustrates an example of mapping data packet sets (e.g., PDU sets) of different importance levels to a quality of service (QoS) flow and/or a radio bearer.

Although the data packet set is referred to as a PDU set in the data packet set mapping diagram 200, the data packet set may be any type of data packet set. In variations, the PDU set may include any numerical quantity of data packets. For example, a PDU set may include PDUs 1, 2, 3, and 4. A PDU set may include an I-frame, a B-frame, and/or a P-frame. Respective PDU sets and/or data packets in a PDU set may be assigned a priority level (e.g., PSI value), a PDU set identifier, and a size that indicates a numerical quantity of data packets in the PDU set. Additionally, or alternatively, although the PDU set is illustrated as including XR data traffic (e.g., for an XR video application), the PDU set may include any type of data traffic. In some examples, the mapping of a PDU set is to a QoS flow. In some other examples, the mapping of a PDU set is to a radio bearer, where a radio bearer represents a logic channel (LCH) established between a UE and an NE and supports transmission of data packets and control information between the UE and the NE. Example types of radio bearers include, but are not limited to, signal radio bearers (SRBs) and data radio bearers (DRBs). SRBs carry signaling information between a UE 104 and NE for establishing, maintaining, and releasing wireless connections between the UE and the NE. DRBs carry user data between the UE 104 and the NE, and are established dynamically (e.g., on-demand) to transmit user data.

In some examples, transmission of a data packet according to a QoS flow and/or radio bearer may be defined by one or more devices and/or entities in a wireless communications system (e.g., the wireless communications system 100). For example, a UE 104 may exchange signaling with a NE, which may include an AMF and/or RAN entity, also referred to as a RAN. The signaling may include XR data traffic. The XR data traffic may include audio data and/or video data. In variations, an RTP may support one or more audio payload types for the XR data traffic, where Table 2 includes examples of supported audio payload types.

TABLE 2
audio payload types

| Payload Type | | | | |
|---|---|---|---|---|
| Number | Audio Format | Sampling Rate | Throughput | |
| 0 | PCM mu-law | 8 kilohertz | 64 kilobits per | |
| | | (KHz) | second (Kbps) | |
| 1 | 1016 | 8 KHz | 4.8 | Kbps |
| 3 | GSM | 8 KHz | 13 | Kbps |
| 7 | LPC | 8 KHz | 2.4 | Kbps |
| 9 | G.722 | 8 KHz | 48-64 | Kbps |
| 14 | MPEG Audio | 90 KHz | — | |
| 15 | G.728 | 8 KHz | 16 | Kbps |

At 202, the XR application function (XRAF) determines PDU set criteria for the XR data traffic (e.g., requirements). In some examples, at 204, the XRAF transmits the PDU set criteria to a policy control function (PCF), where a PCF provides policy rules for control plane functions (e.g., network slicing, roaming, and mobility management). The PDU set criteria includes one or more of PDU set QoS parameters (e.g., PDU set delay budget (PDSB or PSDB), a PDU set error rate (PSER), PDU set integrated indication (e.g., indicating some or all PDUs of PDU set are used for successful decoding), a burst periodicity, which may also include frame rate values, a description of service protocol that indicates an RTP and/or real time streaming protocol (RTSP), or a header type to be used for PDU set identification at a UPF). A PSER is an upper bound for a rate of non-congestion related PDU set losses between a RAN and the UE 104.

At 206, the PCF determines QoS rules for the PDU set. At 208, the SMF determines a QoS profile of a QoS flow, including PDSB and PSER information. At 210, the SMF transmits the QoS profile to the AMF. For example, the SMF transmits a next-generation application protocol (NGAP) message that includes one or more of a periodicity of uplink and downlink traffic of the QoS flow, a jitter range associated with respective periodicities, or an optional end of burst indication. In some examples, the periodicity includes frame rate values (e.g., 15, 20, 30, 45, 60, 72, 90, 120 fps) and a user plane function (UPF) derives jitter based on implementation per periodicity.

In some examples, such as to enable PDU set-based QoS handling, PDU set QoS parameters may be provided by the SMF to the NE 102 as part of the QoS profile of the QoS flow. The QoS parameters may include, but are not limited to, a PSDB, a PSER, and/or PDU Set integrated handling information (PSIHI). A QoS Flow is associated with one PSDB, and when available, the PDSB applies to both downlink and uplink and supersedes the PDB of the QoS flow. An access network (AN) PSDB is derived by subtracting a CN PDB from the PSDB. Additionally, or alternatively, a QoS Flow is associated with one PSER, and when available, the PSER applies to both downlink and uplink and supersedes the packet error rate (PER) of the QoS flow. A PDU set is considered successfully delivered when all PDUs of a PDU set are delivered successfully. A PSIHI indicates whether all PDUs of the PDU set from the PDU set are used by the AL. In variations, the PDU set QoS parameters are common for all PDU sets within a QoS flow. Additionally, or alternatively, the UPF can identify PDUs that belong to PDU sets and may determine PDU set information to send to an NE 102 (e.g., in a GTP-U header). The PDU set information may include a PDU set SN, an indication of an end PDU of the PDU set, a PDU SN within a PDU Set, a PDU set size in bytes, a PSI, which identifies the relative importance of a PDU set compared to other PDU sets within a same QoS flow, or any combination thereof.

At 212, the SMF transmits N4 rules to the UPF. The N4 rules indicate for the UPF to enable PDU set inspection and indicate one or more parameters that indicate to the UPF how to route PDU set packets.

In some examples, at 214, a RTP header extension of an XR packet includes PDU set information. The PDU set information may include one or more of an importance status and/or a size of the PDU set.

At 216, the UPF determines a PDU set from XR packets and routes packets to a corresponding QoS flow according to the N4 rules. In some examples, the UPF may also identify an importance status of the PDU set.

At 218, the RAN receives one or more of QoS flow identifiers (QFIs) or a QoS profile of QoS flow from the SMF (e.g., via an access and mobility management function (AMF)) during a PDU session establishment or modification procedure, which includes PSDB and PSER. The RAN inspects general packet radio service (GPRS) tunnelling protocol user plane (GTP-U) headers and ensures the packets of a same PDU set are handled according to the QoS profile. The RAN may drop lower importance PDU sets if they are not going to be delivered to a UE within a threshold duration. The RAN may mark a start and an end PDU of a PDU set and may ensure the PDU set is delivered to the UE accounting for jitter according to PDSB criteria (e.g., jitter may be an assumed value). When the RAN receives the last PDU of a PDU set then the RAN may deliver the PDU set according to the PDSB.

In some examples, the PSDB defines an upper bound for a delay that a PDU set may experience for the transfer between the UE and an N6 termination point at the UPF (e.g., the time between reception of the first PDU and the successful deliver of the last arrived PDU of a PDU set). The PSDB applies to a downlink PDU set received by the UPF over the N6 interface and to an uplink PDU set sent by a UE. In some cases, such as for one or more defined 5G QoS identifiers (5QIs), the value of the PSDB may be the same in uplink and downlink. In one or more implementations, to support PSDB, a maximum duration threshold is configured and/or defined for inter arrival time between PDUs and a first arrived PDU within the PDU set.

In one or more implementations, PSDB is an optional parameter. If the PCF has a threshold amount of information to determine a PDSB (e.g., sufficient information to determine the PSDB), then the PSDB is used to support the configuration of scheduling and link layer functions.

The PSER defines an upper bound for the rate of PDU sets that have been processed by the sender of a link layer protocol (e.g., a radio link control (RLC) layer protocol) but that are not successfully delivered by the corresponding receiver to the upper layer (e.g., a PDCP layer). Thus, the PSER defines an upper bound for a rate of non-congestion related packet losses. The purpose of the PSER is to provide for appropriate link layer protocol configuration (e.g., RLC and hybrid automatic repeat request (HARQ) in a RAN). For respective 5QIs, a value of a PSER is the same in uplink and downlink. In some examples, if a PDU within the PDU set is not successfully transmitted, then the PDU set is treated as an error. In one or more implementations, a PDU set is considered as successfully delivered when the entirety of a PDU set (e.g., all PDUs of a PDU set) are delivered successfully.

In some cases, a PDU set integrated indication refers to whether an AL uses an entirety of PDUs from a PDU set. PDU set importance is a parameter used to identify the importance of a PDU set within a QoS flow. A RAN may use this parameter for PDU set level packet discarding (e.g., in the presence of congestion).

FIG. 3 illustrates a protocol stack diagram 300, in accordance with aspects of the present disclosure. In some examples, the protocol stack diagram 300 implements aspects of the wireless communications system 100 and/or the data packet set mapping diagram 200. For example, the protocol stack diagram 300 may be implemented by one or more wireless devices, such as a UE 104 and/or an NE 102, as described with reference to FIG. 1. The protocol stack diagram 300 illustrates an example of data packet transmission at different layers in a protocol stack.

In some examples, one or more wireless devices (e.g., a UE 104 and/or an NE 102, as described with reference to FIG. 1) may transmit and/or receive signaling using one or more layers of a protocol stack. A protocol stack includes multiple layers, where respective layers perform one or more functionalities in the transmission and/or reception process. Example layers in the protocol stack include, but are not limited to, a PDCP layer 302, an RLC layer 304, and a MAC layer 306. In some examples, the PDCP layer 302 may perform compression and decompression of user data packets, header compression, and ciphering. In some cases, the RLC layer 304 is part of a data link layer and performs segmentation and reassembly of data packets, error correction, and delivery of higher layer PDUs. In variations, the MAC layer 306 is also part of the data link layer and manages access to a shared radio channel, including scheduling and prioritization of data transmissions and/or random-access procedures. In some examples, the PDCP layer 302 may receive data packets from upper layers, which may include an RRC layer and/or NAS layer.

Although the data packet set is referred to as a PDU set in the protocol stack diagram 300, the data packet set may be any type of data packet set. In variations, the PDU set may include any numerical quantity of data packets. For example, a PDU set may include PDUs 1, 2, 3, and 4. A PDU set may include an I-frame, a B-frame, and/or a P-frame. Respective PDU sets and/or data packets in a PDU set may be assigned a priority level (e.g., PSI value), a PDU set identifier, and a size that indicates a numerical quantity of data packets in the PDU set. In some examples, when the data packets are at the PDCP layer 302, the data packets may be referred to as SDUs.

FIG. 4 illustrates an example of a transmission diagram 400 in accordance with aspects of the present disclosure. In this example, the transmission diagram 400 may be implemented by a UE and/or a NE, which may be examples of the corresponding devices as described with reference to FIGS. 1 through 3. For example, the transmission diagram 400 may illustrate an example of a data packet set 402 for transmission by a UE and/or an NE that includes one or more redundant and/or repair data packets. In variations, the data packet set 402 may be an example of a PDU set and/or a set of ADUs. Additionally, or alternatively, the data packet set 402 may include any type of data packets.

In some examples, a UE and/or an NE may implement FEC, in which the UE and/or the NE add one or more additional data packets to a data packet set 402 for transmission. The additional data packets may include redundant and/or repair data that a receiving device may use to decode the data packet set in the case of lost or corrupted data packets in the data packet set 402. For example, a common content delivery approach of immersive and interactive media (e.g., in cloud gaming, VR), is the application of over-the-top FEC as AL-FEC. This provides for robust multimedia content delivery with reduced latency enabling interactive applications with high bandwidth usage. In some cases, there may be different types of AL-FEC coding schemes, including Raptor coding (e.g., RFC 5032), RaptorQ coding (e.g., RFC 6330), and/or Reed-Solomon codes. A Raptor and/or RaptorQ code is an example of a fountain code, which is a type of erasure code. Fountain codes generate an infinite stream of encoded symbols from a finite set of source symbols. A Reed-Solomon code is an example of a block code, where a message to be transmitted is divided into fixed size blocks, and redundancy (e.g., additional check symbols) are added to each block.

In some examples, a transmitting device determines a set of source data packets 404 (e.g., RTP source packets) representing an ADU as a source block, to be protected jointly based on an AL-FEC coding configuration (e.g., a FECFRAME configuration information containing a FEC scheme identifier, a maximum source block length (MSBL) or alternatively K_max for Raptor and/or RaptorQ, an encoding symbol size, referred to as a T parameter for Raptor/RaptorQ coding schemes, and a repair-window duration representative of a maximum time in ms and/or microseconds that spans the transmission of the source packets and the corresponding repair packets, whereby the transmission point is considered to be downstream interface ingesting encoded PDUs post-encoding). The transmitting device arranges the source data packets 404 (e.g., the RTP source packets) into a set of same-sized source symbols that may represent smaller partitions into source symbols of configured size of data of a source data packet 404. The transmitting device applies a FEC encoding scheme (e.g., Raptor, RaptorQ, Reed-Solomon codes, 2D parity codes) according to the AL-FEC configuration (e.g., FECFRAME Configuration Information) to generate a numerical quantity of repair symbols that make up repair data packets or redundant data packets 406. The transmitting device performs packetization of the repair symbols into the redundant data packets 406 to be used for repair (e.g., RTP repair packets according to RFC 6882) and sends the redundant data packets 406 and the source data packets 404 to a receiver.

In some examples, such as according to FECFRAME criteria (e.g., RFC 6363), the transmitting device nay transmit the source data packets 404 and the redundant data packets 406 in different source and repair flows (e.g., RTP streams, to provide for non-FEC applications processing of source data packets 404 similar to a systematic code). However, it is not precluded that source data packets 404 and redundant data packets 406 are multiplexed under a common encoded data flow (e.g., a RTP stream including both source RTP packets and repair RTP packets). The receiving device receives the source data packets 404 and the redundant data packets 406. If all of the source data packets 404 are successfully received, then the receiving device may not perform FEC recovery and the FEC repair packets can be discarded. If there are however missing source data packets 404, then the receiving device may process the redundant data packets 406 and use the redundant data packets 406 to recover the lost information within a latency corresponding to at least a repair-window time configured by the application FEC configuration.

In variations, Raptor and/or RaptorQ FEC Scheme recovery properties determine that recovery of K encoded source data packets 404 is possible from any K+h coded source data packets 404 or redundant data packets 406 with a probability

$$1 - {\frac{1}{256}}^{h + 1} ,$$

whereby an encoded symbol corresponds to an encoded packet. This implies that recovering K encoded source symbols from a set of N encoded source data packets 404 and redundant data packets 406, where K+1 encoded packets are received is very large (e.g., 99.99%). In some other cases, whereby an encoded packet corresponds to more than one encoded symbol, a high probability of recovery is maintained after packetization, thus providing for Raptor and/or RaptorQ codes to achieve strong error correction performance.

In some cases, such as if a UE implements AL-FEC for an uplink transmission, the UE may not send one or more data packets (e.g., ADUs) directly to a NE. Instead, the UE may add the data packets to a source block that then generates packets of similar or equal size to distribute the content. For example, the UE may add a numerical quantity, K, source data packets 404 to a source block, such that the source block size is K data packets. The data packet set 402 may also have a symbol size, T, where a symbol is a transmission unit in the time domain. The UE may assign one or more encoding symbol identifiers (ESIs) to the data packets. The ESI may be an index for respective data packets and may start at zero. For example, the source block may include a data packet with an ESI of 0, 1, etc., until K−1. In some examples, the source block may include one or more padding bits and/or one or more bits indicating the size, F, of a video frame and/or an object.

For example, a respective data packet set 402, which may include an ADU that carries a video frame and/or an object, has an assigned size, F, and additional characteristics and/or parameters that define the properties of the data packet set 402. The additional characteristics and/or parameters may include a type of the data packet set 402, an importance level (e.g., PSI value), and one or more delay criteria, among others. The characteristics and/or parameters may have different values for respective data packet sets 402. A data packet set 402 forms a source block with K encoding symbols with a size T. A value of K may be different for respective data packet sets 402 in a sequence of data packet sets 402. The initial K encoding symbols form the payload of K source data packets 404, where the data packets may include some of the characteristics and include the source block size, K, as well as an ESI. In addition to K source packets, N−K redundant data packets 406 may be sent as part of the data packet set 402. The redundant data packets 406 may be assigned to a same data packet set 402, for example using a unique transport object identifier (TOI) for a data packet set 402. A redundant data packet 406 may additionally, or alternatively, be referred to as a repair data packet and may be used to repair a data packet set 402 that includes lost source data packets 404.

At the receiving end (e.g., at a receiving wireless device), if the code is maximum distance separable (MDS), such as for RaptorQ or Reed-Solomon codes (e.g., K out of the N packets are sufficient to recover the data packet set 402), then the receiving device collects K symbols, determines the symbol size T based on the payload size, applies FEC decoding, recovers the source block, reads the size F from the K-th source symbols and recovers the data packet set 402 for the next layer in the protocol stack. An FEC payload identifier (e.g., the information carried in a packet header) may carry an ESI and source block size K. As an example, for RaptorQ, the maximum source block size is 56403 and 16 bits are sufficient. In some examples, an ESI field and/or a TOI field may be 1 or 2 bytes.

In some examples, a sender configuration for a data packet set 402 that includes redundant data packets 406 and/or repair data packets may include a symbol size (e.g., symbolSize: 1468), a packet overhead (e.g., packet-overhead: 46), an FEC overhead percent (e.g., fec-overhead-percent: 30). At a receiving device (e.g., an NE if the UE is transmitting an uplink transmission), if one or more data packets of a data packet set 402 are lost, then the timestamp of the loss is the time at which the first lost packet is detected. However, as the data packets may not be delivered in order, a maximum delay of a data packet set 402 may be set, typically compared to the render time, after which only received packets are processed as part of the data packet set 402. If at least K packets are received for a data packet set 402 within the time budget, then the data packet set 402 can be fully recovered. If less than K packets are received, then the data packet set 402 cannot be recovered and an error handling mode can be configured. In some examples, the handling mode may include a data packet set 402 loss. For example, if more than N−K of the data packets associated to the data packet set 402 are lost, then the entire data packet set 402 is lost. In some other examples, the handling mode may include a suffix loss. For example, if more than N−K of the data packets associated to the data packet set 402 are lost, then the correct prefix preceding the first loss of a source data packet 404 is used to generate a partially received data packet set 402.

In some examples, an NE and/or a UE may implement discarding of data packet set 402, also referred to as a PDU set, at a PDCP layer to free up memory in a buffer. For example, the NE may transmit signaling to the UE configuring the UE to implement discarding of a data packet set 402. The signaling may include RRC signaling, a DCI message, and/or a MAC-CE that enable the data packet set 402 discarding at the UE for an uplink transmission. The UE may determine a discard timer for implementing the data packet set 402 discarding. For example, the signaling may explicitly indicate the discard timer and/or the discard timer may be otherwise configured, such as preconfigured, or defined at the UE, and the UE may determine to use the discard timer based on the signaling enabling data packet set 402 discarding. The UE may initialize a timer upon receiving a data packet from upper layers of a protocol stack. Respective data packets of a data packet set 402 may have corresponding discard timers. For example, source data packets 404 in a source block may have a first discard timer, while repair and/or redundant data packets may have a second discard timer with a different value than the first discard timer. The values of the timers may depend on a priority level (e.g., a PSI) of the data packet. That is, source data packets 404 may have a higher PSI level, and thus may have a discard timer with a longer duration, while redundant and/or repair data packets may have a lower PSI level, and thus may have a discard timer with a shorter duration. In variations, the NE may enable data packet set 402 discarding in which the UE discards all redundant and/or repair data packets upon reception of the data packets from upper layers and/or upon transmission of the data packets to lower layers.

In some examples, if a discard timer for a data packet expires (e.g., a discardTimer or discardTimerForLowImportance), then the UE may discard an entire set of data packets that includes the data packets, which may result in degradation of the user perception experience (e.g., quality of experience). For example, at a PDCP layer, the UE may discard all PDCP SDUs belonging to a PDU set to which a PDCP SDU belongs if the timer expires for the PDCP SDU. Additional PDCP SDUs subsequently received from upper layers may also be discarded if they belong to the PDU set. In some examples, if data packet set 402 discarding is not enabled at a UE, then the UE may discard a data packet (e.g., a PDCP SDU along with a corresponding PDCP data PDU). Additionally, or alternatively, if a successful delivery of a data packet (e.g., a PDCP SDU) is confirmed by a status report (e.g., PDCP status report), then a transmitting PDCP entity discards the data packet (e.g., the PDCP SDU along with the corresponding PDCP Data PDU). The status report may be received at the PDCP layer from another layer. If a corresponding PDCP Data PDU has already been submitted to lower layers, then the discard is indicated to the lower layers. For SRBs, when upper layers request a PDCP SDU discard, the PDCP entity shall discard all stored PDCP SDUs and PDCP PDUs. Discarding a PDCP SDU already associated with a PDCP SN causes an SN gap in the transmitted PDCP data PDUs, which increases PDCP reordering delay in the receiving PDCP entity. However, if the UE implements AL-FEC by including redundant and/or repair data packets in a data packet set 402, then discarding all data packets of a data packet set 402 when one of the data packets is lost may result in inefficiencies and a degradation of the user experience.

In some examples, to reduce or eliminate inefficiencies related to data packet set 402 discarding when implementing AL-FEC, a UE may discard a data packet set 402 when a minimum numerical quantity (e.g., number) of data packets of a data packet set 402 is determined to be lost upon expiry of discard timer. For example, at the PDCP layer, a UE may discard all PDCP PDUs and/or SDUs of a corresponding PDU set when a minimum number of PDUs and/or SDUs of the PDU set are lost (e.g., based upon expiry of a PDCP discard timer for a PDU and/or SDU of the PDU set). In some examples, the UE may implement discarding of a data packet set 402 when a minimum number of data packets are lost if data packet set 402 discarding is enabled at the UE (e.g., if pdu-SetDiscard is configured).

In some cases, a counter is introduced that counts a numerical quantity of lost data packets of a data packet set 402 (e.g., PDUs and/or SDUs of a PDU set). The data packets may be considered lost when an associated discard timer expires. For example, the lost data packets may include a number of PDCP SDUs for which the associated discardTimer parameter has expired. If the counter for a data packet set 402 exceeds or meets a configured or defined threshold value, then the UE discards one or more data packets belonging to a data packet set 402. For example, the UE may discard an entirety of the data packets belonging to the data packet set 402 (e.g., all PDCP SDUs belonging to the PDU set to which the PDCP SDU(s) belong along with the corresponding PDCP data PDUs). In some examples, a PDCP layer maintains one counter per data packet set 402 (e.g., PDU set). The new counter is initialized to zero upon reception of a first or initial data packet of the data packet set 402 (e.g., PDU set).

In one or more implementations, an NE configures the threshold value, such as by using information from a CN. The information may include data packet set 402 (e.g., PDU set) related QoS information. For example, the NE may select the threshold value based on QoS information, or other information (e.g., PSI information) for the data packet set 402. In some cases, the NE may select a value greater than one. In some other cases, the NE may select a value equal to one, and the UE may discard the data packet set 402 according to the data packet set 402 discarding without implementing a counter (e.g., no AL-FEC is applied). In one or more other implementations, the UE determines the threshold value. For example, an access stratum (AS) layer of the UE may determine the threshold value using information related to the data packet set 402 (e.g., PDU set) provided by the AL. In some examples, the threshold value may be different for respective data packet sets 402. That is, different data packet sets 402 may have different threshold values for a counter for implementing data packet set 402 (e.g., PDU set) discarding. The threshold value may depend on an AL-FEC configuration, higher layer PDU packetization, AL-FEC redundant information included in the data packet set 402, on a size of the data packet set 402, or any combination thereof. In some cases, the threshold value is provided by RTP extension header information and/or the data packet set 402 related information. Example extension header information includes, but is not limited to, an indication of source data packets 404 (e.g., PDUs), repair data packets, or a number of redundant data packets 406 (e.g., data packets that may be lost without losing the data packet set 402 payload information), among other information.

In variations, the UE discards an entirety, or a complete data packet set 402 if data packet set 402 discarding (e.g., pdu-SetDiscard) is configured and if N−K+1 data packets of the data packet set 402 are determined to be lost (e.g., a PDCP discard timer is expired). In some cases, N denotes the total number of data packets in a data packet set 402 and K denotes the number of source and/or systematic data packets (e.g., in a source block). In some other variations, the N−K+1 value may be determined based on a value indicated for a number of redundant data packets (e.g., N−K). The redundant data packets may be lost during transmission without impact and loss of the data packet set 402 information at a receiver due to the AL-FEC encoding included at the data packets of the data packet set 402.

FIG. 5 illustrates an example of a transmission diagram 500 in accordance with aspects of the present disclosure. In this example, the transmission diagram 500 may be implemented by a UE and/or a NE, which may be examples of the corresponding devices as described with reference to FIGS. 1 through 4. For example, the transmission diagram 500 may illustrate an example of a transmitting device (e.g., a UE) indicating a numerical quantity of data packets for successful decoding of a data packet set to a receiving device (e.g., a NE). In variations, the data packet set may be an example of a PDU set and/or an ADU. Additionally, or alternatively, the data packet set may include any type of data packets.

In some examples, a transmitting device may send one or more data packet sets to a receiving device. For example, in uplink communications, a UE may transmit one or more data packet sets to an NE in an uplink transmission. In some other examples, in downlink communications, an NE may transmit one or more data packets to a UE in a downlink transmission. In some examples, a transmitting device may discard data packets of a data packet set that are deemed as unnecessary (e.g., one or more repair or redundant data packets, as described with reference to FIG. 4). In some examples, if at least K packets are received for a data packet set within a time duration, then the data packet can be fully recovered. A transmitting device may discard one or more remaining (e.g., repair, or alternatively redundant) data packets of a data packet set when a sufficient numerical quantity of data packets is received successfully (e.g., K data packets). For example, a transmitting device may discard a remaining number of SDUs of a PDU set when a threshold number of PDUs and/or SDUs are received. However, the UE may be unable to determine when the threshold number of data packets are received at the receiver side. That is, there may not be an explicit feedback mechanism (e.g., HARQ feedback mechanism) for uplink transmissions. For example, once a transmitting device sends a last packet, there are no additional uplink grants that acknowledge a transport block (TB), and a same HARQ process may be used to acknowledge a HARQ transmission. Thus, a receiving device of an uplink transmission (e.g., a NE) may implement signaling similar to HARQ feedback including a downlink feedback indication (DFI) on PHY layer signaling. Additionally, or alternatively, the NE may provide an acknowledgement (ACK) and/or a negative acknowledgment (NACK) for an uplink transmission on a feedback channel.

In some examples, an NE may be unaware of a size of a data packet set (e.g., a PDU set), thus an NE may be unaware of how many data packets of the data packet set are received. In some other examples, an NE may be unaware of any PDU set related information for an uplink transmission (e.g., the NE may not be aware of which PDUs belong to a PDU set). Thus, an NE may not be able to track data packet sets in uplink transmissions and inform UEs when a defined number of data packets of a data packet set has been successfully received. However, the UE may know which data packets belong to respective uplink data packet sets. In some examples, a transmitting device may transmit a request for a receiving device to send a status report after a numerical quantity of data packets, X, of a data packet set have been transmitted. For example, a UE may transmit a request for a PDCP status report after X SDUs of a PDU set have been transmitted (e.g., considering the HARQ feedback and/or a new data indicator (NDI)) from the PHY layer. In some examples, X is set to a value less than the total number of data packets in a data packet set. In some examples, X is set to the number of source PDUs of a PDU set. For example, X may be three SDUs before the end of a PDU set. In some cases, the UE may set a PDCP status report request bit in a header of a corresponding data packet (e.g., PDCP PDU). For example, the value X may denote the number of PDCP SDUs which are used to successfully decode the PDU set at an AL.

In some cases, a reserved bit in a PDCP header is used to request a PDCP status report. The UE may inform an NE about a SN of a first or initial data packet (e.g., PDCP PDU) of a data packet set and a number of successfully received data packets (e.g., PDPC SDUs) starting from this SN for successful decoding of the data packet set, which may be referred to as an indication of data packets for decoding 502. The UE may include the indication of data packets for decoding 502 in control signaling, such as a MAC-CE or a PDCP control PDU. In some cases, the UE signals the indication of data packets for decoding 502 (e.g., starting from the SN of a PDCP PDU) within the header of a first or initial data packet of a data packet set (e.g., PDCP PDU of a PDU set). A PDCP PDU and PDCP SDU may be similar types of data packets (e.g., neglecting the header, no concatenation or segmentation in PDCP layer), the indication of the initial SN is unambiguous. A NE may determine that N subsequent data packets (e.g., PDCP SDUs and/or PDUs) from the SN of the data packet for which the information is included are to be received successfully for decoding. In some examples, the UE may also indicate an SN of a last data packet of a data packet set to the NE. In some cases, the NE may inform the UE when the NE has received the indicated number of data packets in the indication of data packets for decoding 502. In response to the indication from the NE, the UE may discard remaining pending data packets of a data packet set. The notification from the NE to the UE may be included in control signaling dedicated for the indication, such as a MAC-CE for example.

In some examples, in addition to the indication of data packets for decoding 502, an uplink transmission may include one or more parameters. The parameters may include a PDCP SN value in an Octet 1 and Octet 2. The Octet 1 may additionally, or alternatively, include a data and/or control (D/C) parameter that indicates whether the data packet set is for data or control, a modulation (M) parameter that indicates a modulation type of the data packet set, and one or more reserved (R) parameters. The Octets 4 through N−4 may include data, such as data packets. The Octets N−3 through N may include message authentication code-integrity (MAC-I) information for message integrity protection.

In some examples, a UE may apply a different PDCP discard timer for different PDCP discard timer configurations. For example, a PDCP discard timer value may be different for source PDUs and repair PDUs, or alternatively redundant PDUs, of a PDU set. A NE may configure the UE (e.g., by transmitting signaling indicating information) with a PDCP discard timer configuration for the source PDUs and another PDCP discard timer configuration for the repair PDUs of a PDU set. An AL-FEC PDU set is a PDU set including source PDUs and repair PDUs with PDU set information including an indication of the source and/or repair PDUs. In some cases, repair PDUs may have a lower importance (e.g., PSI level) than source PDUs in a PDU set. Thus, a UE may apply a different PDCP discard timer configuration (e.g., when PSI based discarding is enabled by a NE) for source and repair PDUs. In the case of uplink congestion at a buffer of the UE, a shorter PDCP discard timer configuration for the repair PDUs might be beneficial to reduce the load and reduce and/or eliminate the uplink congestion. Additionally, or alternatively, the UE may be unable to separate source and repair PDUs of a PDU set but may determine a numerical quantity of redundant PDUs (e.g., N−K, in a PDU set). The UE may determine the numerical quantity of redundant PDUs based on RTP header extensions information fields including AL-FEC information (e.g., indicating information about the code rate of the AL-FEC). The NE may configure the UE to apply a different PDCP discard timer value for the N−K PDUs. The value of the PDSP discard timer may be reduced relative to a value of a PDCP discard timer for a remainder of K PDUs of a PDU set (e.g., t_red_discard, or alternatively discardTimerForLowImportance and/or discardTimerForRedundant compared with t_discard). In some examples, the UE may determine the first K PDUs of a PDU set are to be assigned the discard timer value t_discard, whereas the last N−K PDUs of the PDU set are to be assigned a different PDCP discard timer value t_red_discard. In some other examples, the UE may determine (e.g., based on UE specific implementation) which N−K PDUs of the PDU set are to be assigned the discard timer value t_red_discard, and thus implicitly be considered redundant.

In one or more implementations, a different PSI level is associated with repair PDUs, or alternatively redundant PDUs, and source PDUs of a PDU set. In variations, repair PDUs have a lower importance level compared to the source PDUs of a PDU set. In some cases, a PDU set using AL-FEC is associated with two PSI levels (e.g., one for the source PDUs and one for the repair PDUs, or alternatively redundant PDUs). For example, the last N−K PDUs of the PDU set may be considered as the redundant PDUs corresponding to one PSI level (e.g., a low importance PSI value, a PSI value less than a threshold), whereas the first K PDUs of the PDU set may be implicitly considered as the source PDUs of the PDU set corresponding to another PSI level (e.g., a high importance PSI value, a PSI value greater than a threshold). In some examples, redundant and/or repair PDUs of an AL-FEC PDU set are discarded immediately when PSI-based discarding it enabled and/or activated by signaling from a NE. For the case of uplink congestion at a buffer of a UE, the UE may discard the repair or redundant PDUs of an AL-FEC PDU set in order to reduce the load on the uplink air interface. For example, the UE and/or PDCP entity discards redundant PDUs of a PDU set and keeps or sustains a minimum number of PDUs which for a successful decoding of the PDU set is still possible. In variations, the UE and/or PDCP entity discards the repair PDUs of a PDU set immediately (e.g., upon arrival from higher layer) as long as PSI-based discarding is activated. A UE AS may inform the AL and/or another higher layer not to send repair and/or redundant PDUs for a PDU set to a lower layer and/or AS layer. When PSI-based discarding is deactivated, an AS entity may inform a higher layer and/or AL to resume delivery of redundant and/or repair PDUs of a PDU set to the AS entity. In variations, the AS layer of a UE may indicate the AL and/or another higher layer to adapt or change the code rate of the AL-FEC when PSI-based discarding is enabled. The enabling of PSI-based discarding is, in some examples, a trigger to adapt the code rate of the AL-FEC scheme.

In some cases, AL-FEC is applied for specific PDU sets of a radio bearer, QoS flow, and/or an LCH. In variations, the usage of AL-FEC is not bearer-specific but PDU set specific. In some examples, AL-FEC is applied for PDU sets of a defined or specified PSI level. For example, AL-FEC is applied for PDU sets with a PSI level that satisfies a threshold value (e.g., greater than a threshold value, of high importance) to ensure that QoS criteria for the PDU set is satisfied. In one or more implementations, the UE and/or transmitting device informs a receiving device about discarded packets for cases when the discarding is done due to AL-FEC or inter-PDU set dependency (e.g., not PSIHI based discarding).

In some examples, a new PDCP status report (e.g., PDCP discard notification message) is introduced to inform the receiving device of discarded packet at the transmitting device. For example, the new PDCP status report indicates an SN of a first or initial PDCP PDU that is discarded and the number of subsequent consecutive PDCP PDUs which were discarded at the transmitting device. In some cases, the PDCP status report (e.g., PDCP control PDU) includes multiple pairs of fields indicating the SN of the first discarded PDCP PDU and the number of subsequent consecutive PDCP PDUs which are discarded. Thus, the transmitting device may indicate multiple non-consecutive sections of discarded PDCP PDUs. In variations, an NE may indicate to the UE whether to send the discarding notification to the receiving entity. That is, a UE may be configured with whether to send a new PDCP discard status PDU. In some examples, the UE transmits a discard notification message (e.g., PDCP discard status PDU) to the receiving entity if PDCP PDUs and/or SDUs have been discarded due to the discarding of redundant and/or repair PDCP PDUs, such as if a sufficient number of PDCP PDUs of a PDU set have been successfully transmitted and/or received. In some other examples, the UE transmits a PDCP discard notification message if a PDU and/or PDU set has been discarded at a PDCP layer due to a dependency of PDU sets (e.g., due to some inter-dependency of different PDU and/or PDU sets, a PDCP entity discards some PDUs and/or PDU sets at the transmitting device). In variations, the UE may implement a prohibit timer to prevent transmission of a relatively large number of PDCP discard notification messages over a duration (e.g., greater than a threshold value over the duration). The UE may start the prohibit timer in response to the triggering and/or transmission of a PDCP discard notification message. The prohibit timer may reduce or prevent additional signaling overhead caused by the PDCP discard notification messages. In some cases, the UE and/or PDCP entity may transmit a PDCP discard notification message when the prohibit timer is expired (e.g., not running).

In variations, the UE may implement buffer status reporting (BSR) to indicate a volume of a data traffic at the buffer of the UE. In some examples, the BSR signaling may include BSR tables and/or may be triggered according to one or more conditions to reduce one or more quantization errors in BSR reporting for high bit rates and knowledge inaccuracy at a NE, and ultimately to reduce or prevent the overallocation of users to increase capacity. Furthermore, CG signaling may include an indication of unused resources to increase the capacity by more precisely allocating the uplink grants and/or resources to actual data pending at the UE for transmission. Even though a PDU set includes N PDUs (e.g., K source PDUs and N−K repair PDUs), a portion of the N PDUs (e.g., K PDUs) may be used by a receiving device for successful decoding of a PDU set. Thus, the receiving device may not use all of the redundant PDUs for successful decoding of an ADU and/or PDU set. Therefore, in some examples, the UE may discard a remaining portion of PDUs of a PDU set once K PDUs of the PDU set are successfully received by a receiving device. Discarding the unnecessary redundant PDUs may provide for an increase in transmission capacity at the UE.

In some examples, a UE may report a numerical quantity of PDUs for a successful decoding of a corresponding ADU and/or PDU set in a BSR. For example, the UE may report K PDUs and/or SDUs of the PDU set if the total PDU set size is N with N−K repair PDUs. The UE may report K+X PDUs for a PDU set in a BSR, which may represent a PDCP data volume. In some cases, X may be an integer value between 0 and N−K−1. That is, a reported data volume of a PDU set may be smaller than an actual total PDU set size, such that a UE does not consider a total numerical quantity of N−K repair PDUs in the data volume, and instead considers a portion of the N−K repair PDUs. Additionally, or alternatively, if the size of the K PDUs is a numerical quantity of bits (e.g., defined by the parameter K_Size), then the UE may report K_Size*(1+X), where X is greater than or equal to 0 and is a configured value.

In some cases, when calculating a BSR, a UE may consider source PDUs of a PDU set and may not account for repair PDUs. The PDCP entity (e.g., of the transmitting device) considers the source PDUs of a PDU set for a calculation of data volume for the purpose of transmitting a BSR.

In variations, an NE may transmit signaling that configures and/or enables a UE to report a BSR that includes an indication of a numerical quantity of PDUs for a successful decoding of the corresponding ADU and/or PDU set. Instead of reporting the total amount of data of a PDU set, the UE is configured to report the amount/size of PDUs, SDUs, and/or data that is used for a successful decoding of the corresponding PDU set. In some examples, the signaling that configures and/or enables the UE to report the BSR includes control signaling, such as RRC signaling with a new information element that indicates for the UE to transmit a BSR that indicates an amount of data and/or a numerical quantity of PDUs of a PDU set used for a successful decoding of the PDU set. In some other examples, the signaling may include a MAC-CE, which may be referred to as an AL-FEC BSR activation and/or deactivation MAC-CE. The AL-FEC BSR activation and/or deactivation MAC-CE is identified by a MAC subheader with a one-octet LCH identifier. In some cases, the new AL-FEC BSR activation and/or deactivation MAC-CE has a fixed size and includes one octet representative of a bitmap. Respective bits within the bitmap may indicate the activation and/or deactivation status of the AL-FEC BSR of a corresponding DRB, i, where i is the ascending order of the DRB identifier among a set of configured DRBs. A Di field set to 1 indicates that the AL-FEC BSR reporting shall be activated for DRB i. The Di field set to 0 indicates that the AL-FEC BSR reporting shall be deactivated for DRB i.

In one or more implementations, upon arrival of a PDU set with AL-FEC, a multi-stage BSR is triggered. The UE sends a first BSR indicating size of the K PDUs of the PDU set. Additionally, or alternatively, the first BSR may indicate a size with a value a threshold amount greater than the size of the K PDU set. The UE may send a second BSR indicating the size of the remaining N−K PDUs of the PDU set if the UE has not received an indication from an NE indicating that the K PDUs have been received correctly. In some examples, a new BSR trigger is introduced, where the UE triggers a BSR if the UE has not received an indication from an NE indicating that the K PDUs have been received correctly. In some cases, the UE considers a total PDU set size (e.g., source PDUs, as well as repair PDUs or redundant PDUs), when calculating the data volume for the purpose of transmitting a BSR. The UE may transmit signaling to an NE indicating the UE discarded one or more PDUs (e.g., redundant PDUs) of a PDU set.

In some cases, if a remaining delay budget associated with a PDU set with AL-FEC is smaller than a threshold value, then the UE sends a DSR, where the DSR includes a remaining buffer size (RBS) associated with the PDU set. The UE may calculate the RBS using a remaining data size of the K PDUs or K*(1+Y) PDUs, where Y can be configured different than X. In some cases, a DSR and/or a BSR (e.g., triggered for a PDU set with AL-FEC) is considered canceled if an NE determines that at least K PDUs of the PDU set are received. For example, the NE may send an indication in control signaling, such as via a MAC-CE, to the UE indicating at least K PDUs of the PDU set have been received. In variations, an NE may transmit signaling that enables and/or disables a UE to report a numerical quantity of PDUs used (e.g., required) for a successful decoding of a corresponding ADU and/or PDU set in a BSR.

In one or more implementations, a UE may trigger a BSR when the UE determines that one or more allocated uplink time-frequency resources (e.g., CG resources for XR traffic) are not sufficient (e.g., do not satisfy a threshold) to transmit the complete data. According to one implementation of the embodiment, a new BSR trigger is introduced to inform an NE that the allocated uplink time-frequency resources (e.g., multiple CG resources within a CG period) are insufficient for the transmission of the corresponding uplink data (e.g., data of a XR service). In some examples, a MAC entity determines CG PUSCH occasions within a CG period of a configured uplink grant configured with unused transmission occasions (UTO)-UCI as to be unused for PUSCH transmissions based on the data availability of one or more LCHs for which the configured uplink grant is in the list of one or more CGs to use for transmission. A UE may trigger a BSR if it determines that the CG PUSCH occasions within a CG period of a configured uplink grant are not sufficient to accommodate the data of the LCHs for which the configured uplink grant is in the list of CGs. In order to make this determination, the UE may use indicated PDU set size information provided in the PDU set related information (e.g., from an RTP extension header). In some cases, the UE may trigger a BSR based on an expected or estimated data volume (e.g., based on provided PDU set size information). Conventionally, a UE and/or MAC entity may trigger a BSR based on the data pending at a UE buffer of the UE, whereas as described herein, the UE determines whether to trigger a BSR based on the expected data volume (e.g., expected data received at PDCP layer from higher layer). For example, for cases where the UE receives an indication from a higher layer that a size of a next PDU set is greater than a threshold value, a UE and/or a MAC entity may use the provided information to check whether the allocated CG PUSCH resources are sufficient to transmit the PDU set. In some cases, the allocated CG PUSCHs are not sufficient, and the UE and/or the MAC entity triggers a BSR to request for additional uplink resources.

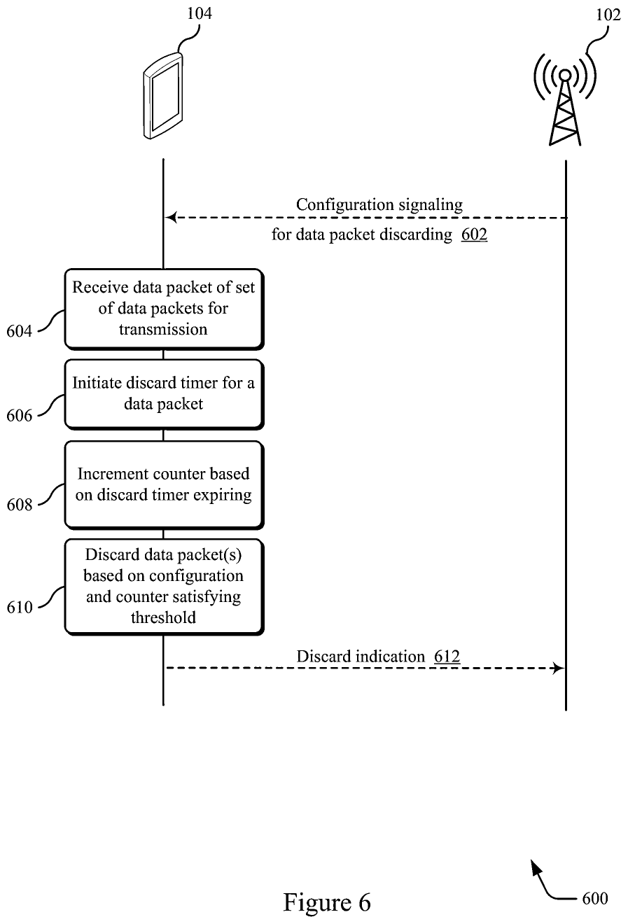

FIG. 6 illustrates an example of a signaling diagram 600 in accordance with aspects of the present disclosure. In some examples, the signaling diagram 600 may implement aspects of the wireless communications system 100, the data packet set mapping diagram 200, the protocol stack diagram 300, the transmission diagram 400, and the transmission diagram 500. The signaling diagram 600 may illustrate an example of a counter mechanism for discarding data packets at a UE 104 for a data packet set that the UE 104 sends to an NE 102 using FEC techniques (e.g., AL-FEC). The UE 104 and the NE 102 may be examples of corresponding devices as described with reference to FIGS. 1 through 5. Alternative examples of the following may be implemented, where some processes are performed in a different order than described or are not performed. In some cases, processes may include additional features not mentioned below, or further processes may be added. In some examples, the NE 102 may be an example of a base station.

In some examples, at 602, the UE 104 may receive configuration signaling for data packet discarding. For example, the signaling may indicate a configuration specifying PDCP discarding of a data packet and/or a set of data packets. In some examples, the data packet may be an SDU and/or a PDU of a PDU set or an ADU. In some cases, the signaling includes one or more of information corresponding to the set of data packets, such as a size of the set of data packets, and a header with a value of at least one parameter that indicates a threshold value for a counter for discarding a data packet and/or a set of data packets. For example, the signaling may include RTP extension header information together with PDU set related information. In variations, the configuration may indicate for the UE 104 to discard an entirety of the set of data packets if the counter satisfies the threshold value.

At 604, the UE 104 may receive a data packet of a set of data packets for transmission. For example, the UE 104 may receive the data packet from an upper layer of a protocol stack. In some cases, the data packet includes an SDU received from an upper layer of a protocol stack and the set of data packets includes a PDCP PDU set.

At 606, the UE 104 may initiate or start a discard timer for a data packet. For example, the UE 104 may initiate a PDCP discard timer configured by the NE 102 via control signaling (e.g., RRC signaling, a MAC-CE) that enables PDCP PDU set discarding at the UE 104. The timer may correspond to reception and/or transmission of the data packet. The UE 104 initiates the discard timer upon receiving a data packet from an upper layer of a protocol stack and/or upon submitting the data packet to a lower layer of the protocol stack for transmission. If the timer expires prior to transmitting the data packet, then the UE 104 may discard a data packet set according to the configuration received at 602.

At 608, the UE 104 increments a counter based on the discard timer expiring. For example, the UE 104 may reset the counter for a first or initial data packet of a data packet set and may increment the counter for respective data packets of the set of data packets for which the discard timer expires.

At 610, the UE 104 may discard one or more data packets based on the configuration at 602 and based on the counter satisfying a threshold value. For example, if the configuration indicates for the UE 104 to discard an entirety of a set of data packets, then the UE 104 may discard respective data packets that have been received for a set of data packets, as well as any additional data packets that are received from the set of data packets. In some examples, the NE 102 configures the threshold value (e.g., in same configuration signaling as the configuration signaling for the data packet discarding and/or in different configuration signaling as the configuration signaling for the data packet discarding).

In some examples, at 612, the UE 104 may transmit a discard indication to the NE 102. For example, the UE 104 may transmit signaling to an NE 102 that indicates the data packets are discarded. In some cases, the signaling includes a status report indicating an SN of the data packet and a numerical quantity of subsequent consecutive discarded data packets, where the data packet is an initial data packet to be discarded from the set of data packets. In some examples, the UE 104 may transmit first signaling that requests transmission of second signaling that indicates the data packet has been received. For example, the UE 104 may transmit control signaling (e.g., an UCI message) that requests an indication (e.g., a PDCP status report) that the NE 102 has received one or more data packets. The additional signaling may be sent in same configuration signaling as the configuration signaling at 602 or in different configuration signaling. In some cases, the UE 104 may initiate a prohibit timer upon transmitting the signaling including the discard indication. The UE 104 may refrain from transmitting (e.g., cancel transmission and/or not transmit) additional signaling that indicates an additional data packet is discarded until expiry of the prohibit timer.

In some examples, the UE 104 may determine the set of data packets includes one or more redundant data packets if the threshold value is greater than one. If the set of data packets does not include one or more redundant data packets, and if data packet set discarding is enabled, then the UE 104 may discard a set of data packets upon expiration of a single discard timer for a data packet.

In some examples, the NE 102 may implicitly indicate the threshold value to the UE 104. For example, the NE 102 may transmit signaling that indicates information related to the set of data packets. The information may include at least one of a FEC configuration, higher layers data packetization information, FEC redundancy information within the set of data packets, or a numerical quantity of data packets corresponding to the set of data packets. The UE 104 may determine the threshold value based on the information. In some other examples, the NE 102 may explicitly indicate the threshold value to the UE 104. For example, the NE 102 may select a value greater than one for the threshold value if the set of data packets include redundant data packets (e.g., for AL-FEC). In some other examples, the NE 102 may select a value equal to one for the threshold value if the set of data packets do not include redundant data packets (e.g., no AL-FEC). The NE 102 may transmit control signaling indicating the selected threshold value.

In some examples, different sets of data packets have different threshold values for the counter, such that the counter is unique to a data set. In some cases, the threshold value is based on a difference between a total numerical quantity of data packets in the set of data packets and a numerical quantity of source data packets in the set of data packets or a numerical quantity of redundant data packets, where the set of data packets includes one or more source data packets and one or more redundant data packets.

In some examples, if the set of data packets includes one or more source data packets and one or more redundant data packets, then the timer includes at least one of a first duration for the one or more source data packets or a second duration different from the first duration for the one or more redundant data packets. That is, a value of the timer may be different for source data packets than for redundant data packets. The value of the timer may be longer for source data packets than for redundant data packets to account for a priority level (e.g., PSI value) of the data packets. For example, the data packets may be assigned different PSI values (e.g., by an NE 102 and/or based on configured or otherwise defined values), and the UE 104 may determine a duration of a timer for the data packets according to the different PSI values (e.g., based on a configuration received from the NE 102).

In some examples, the set of data packets include source data packets and redundant data packets, and the configuration indicates for the UE 104 to discard the redundant data packets. The UE 104 may discard the redundant data packets and may not discard the source data packets according to the configuration.

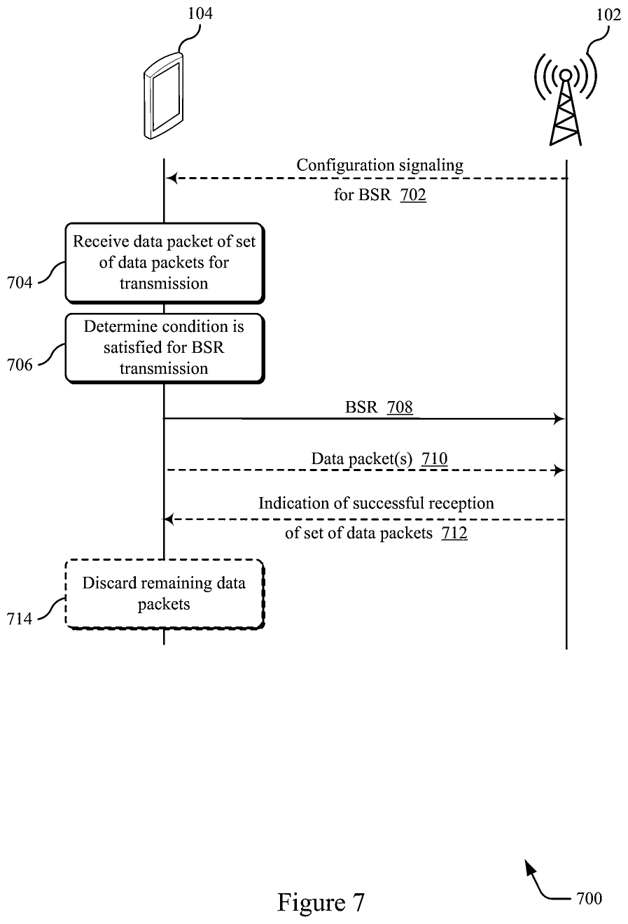

FIG. 7 illustrates an example of a signaling diagram 700 in accordance with aspects of the present disclosure. In some examples, the signaling diagram 700 may implement aspects of the wireless communications system 100, the data packet set mapping diagram 200, the protocol stack diagram 300, the transmission diagram 400, the transmission diagram 500, and the signaling diagram 700. The signaling diagram 700 may illustrate an example of a UE 104 transmitting a BSR for a data packet set that the UE 104 sends to an NE 102 using FEC techniques (e.g., AL-FEC). The UE 104 and the NE 102 may be examples of corresponding devices as described with reference to FIGS. 1 through 6. Alternative examples of the following may be implemented, where some processes are performed in a different order than described or are not performed. In some cases, processes may include additional features not mentioned below, or further processes may be added. In some examples, the NE 102 may be an example of a base station.

In some cases, at 702, the NE 102 may transmit configuration signaling for a BSR. For example, the NE 102 may transmit signaling indicating the configuration for transmitting the BSR to the UE 104. In some cases, the signaling includes an IE (e.g., in RRC signaling) that indicates an activation of the configuration for transmitting the BSR. In some other cases, the signaling includes a bitmap indicating an activation of the configuration for transmitting the BSR for respective DRBs. The configuration indicates for the BSR to indicate and/or include a data volume for transmission of the first subset of data packets and a portion of data packets of the second subset of data packets. A numerical quantity of data packets in the portion of data packets may be based on a numerical quantity of data packets for successful decoding of the set of data packets. In some cases, a numerical quantity of data packets in the portion of data packets of the second subset of data packets is less than a numerical quantity of data packets in the second subset of data packets.

At 704, the UE 104 may receive a data packet of a set of data packets for transmission. For example, the UE 104 may receive the data packet from an upper layer of a protocol stack. The data packet may be an example of an SDU of a PDCP PDU set. The set of data packets may include a first subset of data packets and a second subset of data packets. For example, the first subset of data packets may include one or more source data packets and the second subset of data packets may include one or more redundant data packets (e.g., also referred to as repair data packets).

At 706, the UE 104 may determine a condition is satisfied for BSR transmission. In some examples, the condition for reporting the BSR is based on a determination that a numerical quantity of time-frequency resources allocated for transmission of the set of data packets fails to satisfy a threshold value corresponding to the data volume. That is, the UE 104 may determine to transmit a BSR if there are an insufficient number of time-frequency resources (e.g., CG resources) allocated for an uplink transmission. In some other examples, the condition is satisfied if the set of data packets includes one or more source data packets and one or more redundant data packets.

At 708, the UE 104 may transmit the BSR to the NE 102. For example, the UE 104 may transmit the BSR based on the configuration received at 702. The BSR may indicate a data volume for transmitting the first subset of data packets and a portion of data packets of the second subset of data packets.

In some cases, at 710, the UE 104 may transmit one or more data packets to the NE 102. For example, the UE 104 may transmit the first subset of data packets and the portion of data packets of the second subset of data packets (e.g., a portion of redundant data packets) to the NE 102. In some cases, a data packet of the first subset of data packets and the portion of data packets includes a header that requests a status report from the NE 102. In some examples, the UE 104 transmits signaling that indicates an SN of an initial data packet of the set of data packets and a numerical quantity of data packets included in the first subset of data packets and the portion of data packets of the second subset of data packets. In variations, the signaling is included in a header of the initial data packet.

In some cases, header information for at least one data packet indicates a numerical quantity of data packets in the portion of data packets. Additionally, or alternatively, header information for at least one data packet indicates a numerical quantity of data packets in the set of data packets.

In some examples, at 712, the NE 102 transmits an indication of successful reception of the data packets to the UE 104. For example, the UE 104 may receive additional signaling from the NE 102 that indicates the numerical quantity of data packets of the first subset of data packets and the portion of data packets of the second subset of data packets are received successfully (e.g., received and decoded without errors).

In some cases, at 714, the UE 104 may discard one or more remaining data packets. For example, the UE 104 may discard a remaining portion of data packets of the second subset of data packets. The portion of data packets of the second subset of data packets is different from the remaining portion of data packets of the second subset of data packets.

In some examples, the UE 104 may monitor for signaling indicating that the first subset of data packets is received, where the BSR indicates the first subset of data packets. In some cases, the UE 104 may not receive the signaling and may transmit an additional BSR indicating the second subset of data packets.

In some cases, the UE 104 may determine a remaining delay budget for the set of data packets satisfies a threshold value. The UE 104 may transmit a DSR indicating an RBS for the set of data packets. Prior to transmitting the DSR, the UE 104 may receive signaling that activates an additional configuration for the DSR. The additional configuration indicates for the DSR to indicate the data volume associated with the first subset of data packets and the portion of data packets of the second subset of data packets.

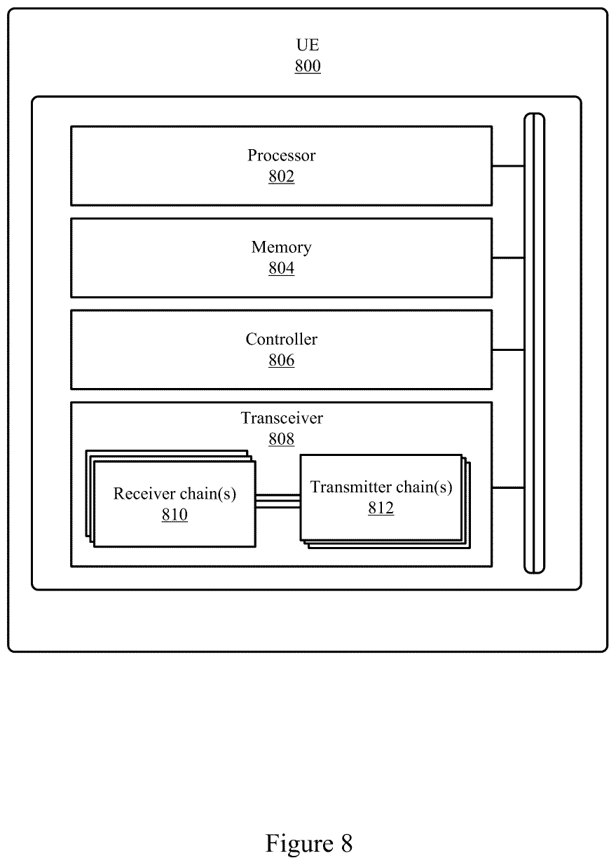

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to or operable to support a means for receiving a data packet associated with a set of data packets for transmission, where a timer corresponding to reception of the data packet is initiated based on receiving the data packet, incrementing a counter associated with the set of data packets based on a determination that the timer has expired, and discarding the data packet of the set of data packets based on the counter satisfying a threshold value and a configuration associated with the discarding of the data packet.

Additionally, the UE 800 may be configured to support any one or combination of receiving signaling indicating the configuration. Additionally, or alternatively, the signaling includes one or more of information corresponding to the set of data packets or a header with a value of at least one parameter corresponding to the threshold value. Additionally, or alternatively, the configuration indicates for the UE to discard an entirety of the set of data packets based on the counter satisfying the threshold value, and the UE 800 may be configured to support discarding the entirety of the set of data packets based on the configuration. Additionally, or alternatively, the UE 800 may be configured to support transmitting, to a base station, signaling that indicates the data packet is discarded. Additionally, or alternatively, the signaling includes a status report indicating an SN of the data packet and a numerical quantity of subsequent consecutive discarded data packets, and where the data packet is an initial data packet to be discarded from the set of data packets. Additionally, or alternatively, the UE 800 may be configured to support transmitting first signaling that requests transmission of second signaling that indicates the data packet has been received. Additionally, or alternatively, the UE 800 may be configured to support initiating a prohibit timer based on transmitting the signaling, and refraining from transmitting additional signaling that indicates an additional data packet is discarded until expiry of the prohibit timer. Additionally, or alternatively, the UE 800 may be configured to support determining that the set of data packets includes one or more redundant data packets based on the threshold value being greater than one. Additionally, or alternatively, the UE 800 may be configured to support receiving signaling that indicates information corresponding to the set of data packets and determining the threshold value based on the information corresponding to the set of data packets. Additionally, or alternatively, the information corresponding to the set of data packets includes at least one of a FEC configuration, higher layers data packetization information, FEC redundancy information within the set of data packets, or a numerical quantity of data packets corresponding to the set of data packets.

Additionally, or alternatively, the threshold value is unique to the set of data packets. Additionally, or alternatively, the threshold value corresponds to at least one of a difference between a total numerical quantity of data packets in the set of data packets and a numerical quantity of source data packets in the set of data packets or a numerical quantity of redundant data packets, and where the set of data packets includes one or more source data packets and one or more redundant data packets. Additionally, or alternatively, the set of data packets includes one or more source data packets and one or more redundant data packets, and where the timer includes at least one of a first duration corresponding to the one or more source data packets or a second duration different from the first duration corresponding to the one or more redundant data packets. Additionally, or alternatively, the set of data packets includes one or more source data packets and one or more redundant data packets, and where the UE 800 may be configured to support discarding the one or more redundant data packets based on the configuration indicating for the UE to discard the one or more redundant data packets. Additionally, or alternatively, the set of data packets includes one or more source data packets and one or more redundant data packets based on a priority level of the set of data packets. Additionally, or alternatively, the counter is reset based on receiving an initial data packet associated with the set of data packets. Additionally, or alternatively, the data packet includes an SDU received from an upper layer of a protocol stack, and where the set of data packets include a PDCP PDU set. Additionally, or alternatively, the timer includes a PDCP discard timer.

Additionally, or alternatively, the UE 800 may support at least one memory (e.g., the memory 804) and at least one processor (e.g., the processor 802) coupled with the at least one memory and configured to cause the UE to: receive a data packet associated with a set of data packets for transmission, where a timer corresponding to reception of the data packet is initiated based on receiving the data packet, increment a counter associated with the set of data packets based on a determination that the timer has expired, and discard the data packet of the set of data packets based on the counter satisfying a threshold value and a configuration associated with the discarding of the data packet.

Additionally, the UE 800 may be configured to support any one or combination of the at least one processor is configured to receive signaling indicating the configuration. Additionally, or alternatively, the signaling includes one or more of information corresponding to the set of data packets or a header with a value of at least one parameter corresponding to the threshold value. Additionally, or alternatively, the configuration indicates for the UE 800 to discard an entirety of the set of data packets based on the counter satisfying the threshold value, and where the at least one processor is configured to discard the entirety of the set of data packets based on the configuration. Additionally, or alternatively, the at least one processor is configured to transmit, to a base station, signaling that indicates the data packet is discarded. Additionally, or alternatively, the signaling includes a status report indicating an SN of the data packet and a numerical quantity of subsequent consecutive discarded data packets, and where the data packet is an initial data packet to be discarded from the set of data packets. Additionally, or alternatively, the at least one processor is configured to transmit first signaling that requests transmission of second signaling that indicates the data packet has been received. Additionally, or alternatively, the at least one processor is configured to initiate a prohibit timer based on transmitting the signaling, and refrain from transmitting additional signaling that indicates an additional data packet is discarded until expiry of the prohibit timer. Additionally, or alternatively, the at least one processor is configured to determine that the set of data packets includes one or more redundant data packets based on the threshold value being greater than one. Additionally, or alternatively, the at least one processor is configured to receive signaling that indicates information corresponding to the set of data packets and determine the threshold value based on the information corresponding to the set of data packets. Additionally, or alternatively, the information corresponding to the set of data packets includes at least one of a FEC configuration, higher layers data packetization information, FEC redundancy information within the set of data packets, or a numerical quantity of data packets corresponding to the set of data packets.

Additionally, or alternatively, the threshold value is unique to the set of data packets. Additionally, or alternatively, the threshold value corresponds to at least one of a difference between a total numerical quantity of data packets in the set of data packets and a numerical quantity of source data packets in the set of data packets or a numerical quantity of redundant data packets, and where the set of data packets includes one or more source data packets and one or more redundant data packets. Additionally, or alternatively, the set of data packets includes one or more source data packets and one or more redundant data packets, and where the timer includes at least one of a first duration corresponding to the one or more source data packets or a second duration different from the first duration corresponding to the one or more redundant data packets. Additionally, or alternatively, the set of data packets includes one or more source data packets and one or more redundant data packets, and where the at least one processor is configured to discard the one or more redundant data packets based on the configuration indicating for the UE 800 to discard the one or more redundant data packets. Additionally, or alternatively, the set of data packets includes one or more source data packets and one or more redundant data packets based on a priority level of the set of data packets. Additionally, or alternatively, the counter is reset based on receiving an initial data packet associated with the set of data packets. Additionally, or alternatively, the data packet includes an SDU received from an upper layer of a protocol stack, and where the set of data packets include a PDCP PDU set. Additionally, or alternatively, the timer includes a PDCP discard timer.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

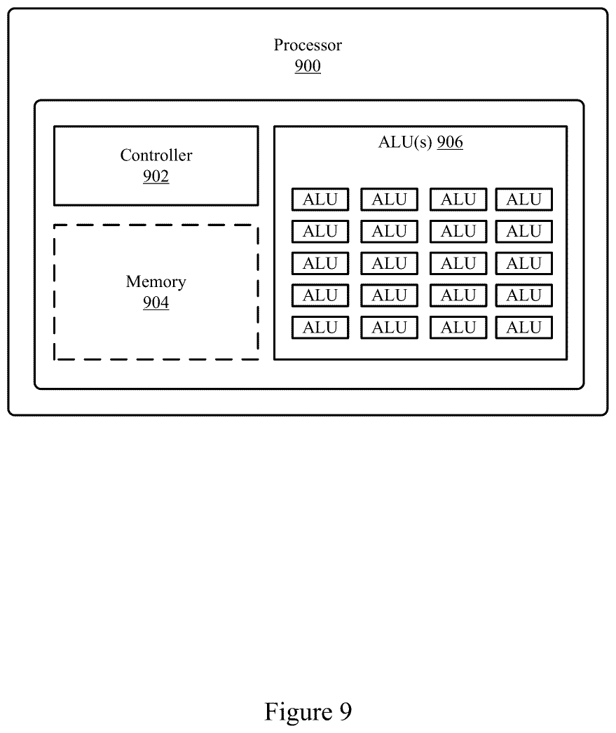

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to: receive a data packet associated with a set of data packets for transmission, where a timer corresponding to reception of the data packet is initiated based on receiving the data packet, increment a counter associated with the set of data packets based on a determination that the timer has expired, and discard the data packet of the set of data packets based on the counter satisfying a threshold value and a configuration associated with the discarding of the data packet.

Additionally, the processor 900 may be configured to or operable to support any one or combination of the at least one controller is configured to cause the processor to receive signaling indicating the configuration. Additionally, or alternatively, the signaling includes one or more of information corresponding to the set of data packets or a header with a value of at least one parameter corresponding to the threshold value. Additionally, or alternatively, the configuration indicates for the processor 900 to discard an entirety of the set of data packets based on the counter satisfying the threshold value, and the processor discards the entirety of the set of data packets based on the configuration. Additionally, or alternatively, the at least one controller is configured to cause the processor to transmit, to a base station, signaling that indicates the data packet is discarded. Additionally, or alternatively, the signaling includes a status report indicating an SN of the data packet and a numerical quantity of subsequent consecutive discarded data packets, and where the data packet is an initial data packet to be discarded from the set of data packets. Additionally, or alternatively, the at least one controller is configured to cause the processor to transmit first signaling that requests transmission of second signaling that indicates the data packet has been received. Additionally, or alternatively, the at least one controller is configured to cause the processor to initiate a prohibit timer based on transmitting the signaling, and refrain from transmitting additional signaling that indicates an additional data packet is discarded until expiry of the prohibit timer. Additionally, or alternatively, the at least one controller is configured to cause the processor to determine that the set of data packets includes one or more redundant data packets based on the threshold value being greater than one. Additionally, or alternatively, the at least one controller is configured to cause the processor to receive signaling that indicates information corresponding to the set of data packets and determine the threshold value based on the information corresponding to the set of data packets. Additionally, or alternatively, the information corresponding to the set of data packets includes at least one of a FEC configuration, higher layers data packetization information, FEC redundancy information within the set of data packets, or a numerical quantity of data packets corresponding to the set of data packets.

Additionally, or alternatively, the threshold value is unique to the set of data packets. Additionally, or alternatively, the threshold value corresponds to at least one of a difference between a total numerical quantity of data packets in the set of data packets and a numerical quantity of source data packets in the set of data packets or a numerical quantity of redundant data packets, and where the set of data packets includes one or more source data packets and one or more redundant data packets. Additionally, or alternatively, the set of data packets includes one or more source data packets and one or more redundant data packets, and where the timer includes at least one of a first duration corresponding to the one or more source data packets or a second duration different from the first duration corresponding to the one or more redundant data packets. Additionally, or alternatively, the set of data packets includes one or more source data packets and one or more redundant data packets, and where the at least one controller is configured to cause the processor to discard the one or more redundant data packets based on the configuration indicating for the processor to discard the one or more redundant data packets. Additionally, or alternatively, the set of data packets includes one or more source data packets and one or more redundant data packets based on a priority level of the set of data packets. Additionally, or alternatively, the counter is reset based on receiving an initial data packet associated with the set of data packets. Additionally, or alternatively, the data packet includes an SDU received from an upper layer of a protocol stack, and where the set of data packets include a PDCP PDU set. Additionally, or alternatively, the timer includes a PDCP discard timer.

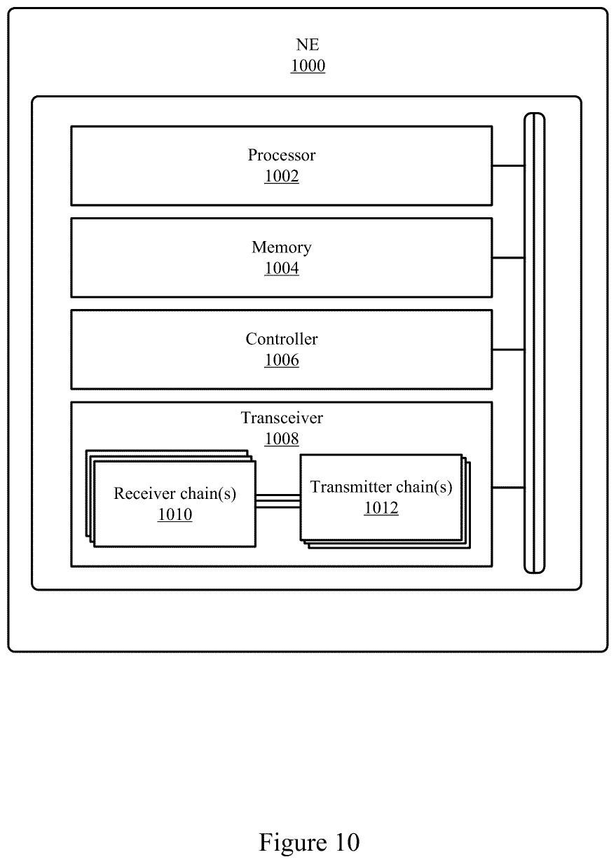

FIG. 10 illustrates an example of an NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to or operable to support a means for transmitting, to a UE, first signaling that indicates a timer associated with respective data packets in a set of data packets for transmission by the UE, and transmitting, to the UE, second signaling that indicates a configuration associated with discarding a data packet of the set of data packets based on a counter satisfying a threshold value.

Additionally, the NE 1000 may be configured to or operable to support any one or combination of the configuration indicates for the UE to discard an entirety of the set of data packets based on the counter satisfying the threshold value. Additionally, or alternatively, the first signaling indicates at least one of information corresponding to the set of data packets or a header with a value of at least one parameter corresponding to the threshold value. Additionally, or alternatively, the information corresponding to the set of data packets includes at least one of a FEC configuration, higher layers data packetization information, FEC redundancy information within the set of data packets, or a numerical quantity of data packets corresponding to the set of data packets. Additionally, or alternatively, the NE 1000 may be configured to support receiving, from the UE, third signaling that indicates the data packet is discarded. Additionally, or alternatively, the third signaling includes a status report indicating an SN of the data packet and a numerical quantity of subsequent consecutive discarded data packets, and where the data packet is an initial data packet to be discarded from the set of data packets. Additionally, or alternatively, the NE 1000 may be configured to support receiving, from the UE, third signaling that requests transmission of fourth signaling that indicates the data packet has been received. Additionally, or alternatively, the NE 1000 may be configured to support selecting a value greater than one for the threshold value based on the set of data packets including one or more redundant data packets. Additionally, or alternatively, the NE 1000 may be configured to support selecting a value equal to one for the threshold value based on the set of data packets failing to include one or more redundant data packets.

Additionally, or alternatively, the threshold value is unique to the set of data packets. Additionally, or alternatively, the threshold value corresponds to at least one of a difference between a total numerical quantity of data packets in the set of data packets and a numerical quantity of source data packets in the set of data packets or a numerical quantity of redundant data packets, and where the set of data packets includes one or more source data packets and one or more redundant data packets. Additionally, or alternatively, the set of data packets includes one or more source data packets and one or more redundant data packets, and where the timer includes at least one of a first duration corresponding to the one or more source data packets or a second duration different from the first duration corresponding to the one or more redundant data packets. Additionally, or alternatively, the set of data packets includes one or more source data packets and one or more redundant data packets, and where the configuration indicates for the UE to discard the one or more redundant data packets. Additionally, or alternatively, the set of data packets includes one or more source data packets and one or more redundant data packets based on a priority level of the set of data packets. Additionally, or alternatively, the data packet includes an SDU received from an upper layer of a protocol stack, and where the set of data packets include a PDCP PDU set. Additionally, or alternatively, the timer includes a PDCP discard timer.

Additionally, or alternatively, the NE 1000 may support at least one memory (e.g., the memory 1004) and at least one processor (e.g., the processor 1002) coupled with the at least one memory and configured to cause the NE to: transmit, to a UE, first signaling that indicates a timer associated with respective data packets in a set of data packets for transmission by the UE, and transmit, to the UE, second signaling that indicates a configuration associated with discarding a data packet of the set of data packets based on a counter satisfying a threshold value.

Additionally, the NE 1000 may be configured to support any one or combination of the configuration indicates for the UE to discard an entirety of the set of data packets based on the counter satisfying the threshold value. Additionally, or alternatively, the first signaling indicates at least one of information corresponding to the set of data packets or a header with a value of at least one parameter corresponding to the threshold value. Additionally, or alternatively, the information corresponding to the set of data packets includes at least one of a FEC configuration, higher layers data packetization information, FEC redundancy information within the set of data packets, or a numerical quantity of data packets corresponding to the set of data packets. Additionally, or alternatively, the at least one processor is configured to cause the NE 1000 to receive, from the UE, third signaling that indicates the data packet is discarded. Additionally, or alternatively, the third signaling includes a status report indicating an SN of the data packet and a numerical quantity of subsequent consecutive discarded data packets, and where the data packet is an initial data packet to be discarded from the set of data packets. Additionally, or alternatively, at least one processor is configured to cause the NE 1000 to receive, from the UE, third signaling that requests transmission of fourth signaling that indicates the data packet has been received. Additionally, or alternatively, at least one processor is configured to cause the NE 1000 to select a value greater than one for the threshold value based on the set of data packets including one or more redundant data packets. Additionally, or alternatively, at least one processor is configured to cause the NE 1000 to select a value equal to one for the threshold value based on the set of data packets failing to include one or more redundant data packets.

Additionally, or alternatively, the threshold value is unique to the set of data packets. Additionally, or alternatively, the threshold value corresponds to at least one of a difference between a total numerical quantity of data packets in the set of data packets and a numerical quantity of source data packets in the set of data packets or a numerical quantity of redundant data packets, and where the set of data packets includes one or more source data packets and one or more redundant data packets. Additionally, or alternatively, the set of data packets includes one or more source data packets and one or more redundant data packets, and where the timer includes at least one of a first duration corresponding to the one or more source data packets or a second duration different from the first duration corresponding to the one or more redundant data packets. Additionally, or alternatively, the set of data packets includes one or more source data packets and one or more redundant data packets, and where the configuration indicates for the UE to discard the one or more redundant data packets. Additionally, or alternatively, the set of data packets includes one or more source data packets and one or more redundant data packets based on a priority level of the set of data packets. Additionally, or alternatively, the data packet includes an SDU received from an upper layer of a protocol stack, and where the set of data packets include a PDCP PDU set. Additionally, or alternatively, the timer includes a PDCP discard timer.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

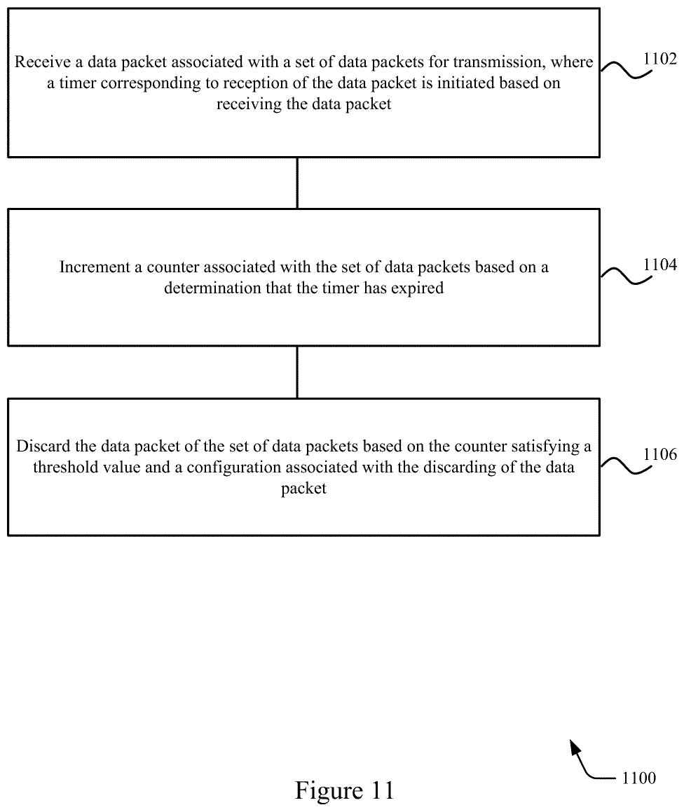

FIG. 11 illustrates a flowchart of a method 1100 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1102, the method may include receiving a data packet associated with a set of data packets for transmission, where a timer corresponding to reception of the data packet is initiated based on receiving the data packet. The operations of 1102 may be performed in accordance with examples as described herein. In some implementations, aspects of the operations of 1102 may be performed by a UE as described with reference to FIG. 8.

At 1104, the method may include incrementing a counter associated with the set of data packets based on a determination that the timer has expired. The operations of 1104 may be performed in accordance with examples as described herein. In some implementations, aspects of the operations of 1104 may be performed by a UE as described with reference to FIG. 8.

At 1106, the method may include discarding the data packet of the set of data packets based on the counter satisfying a threshold value and a configuration associated with the discarding of the data packet. The operations of 1106 may be performed in accordance with examples as described herein. In some implementations, aspects of the operations of 1106 may be performed a UE as described with reference to FIG. 8.

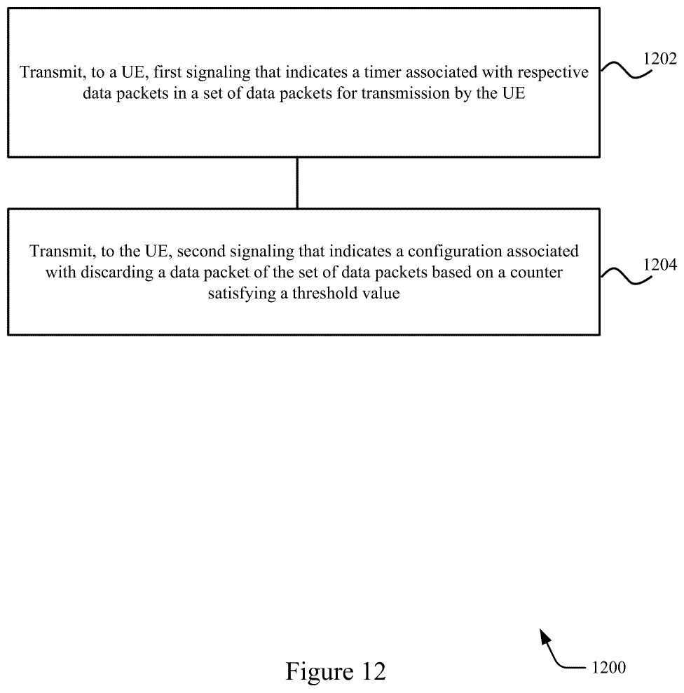

FIG. 12 illustrates a flowchart of a method 1200 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include transmitting, to a UE, first signaling that indicates a timer associated with respective data packets in a set of data packets for transmission by the UE. The operations of 1202 may be performed in accordance with examples as described herein. In some implementations, aspects of the operations of 1202 may be performed by an NE as described with reference to FIG. 10.

At 1204, the method may include transmitting, to the UE, second signaling that indicates a configuration associated with discarding a data packet of the set of data packets based on a counter satisfying a threshold value. The operations of 1204 may be performed in accordance with examples as described herein. In some implementations, aspects of the operations of 1204 may be performed by an NE as described with reference to FIG. 10.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a data packet associated with a set of data packets for transmission, wherein a timer corresponding to reception of the data packet is initiated based at least in part on receiving the data packet;
increment a counter associated with the set of data packets based at least in part on a determination that the timer has expired; and
discard the data packet of the set of data packets based at least in part on the counter satisfying a threshold value and a configuration associated with the discarding of the data packet.

2. The UE of claim 1, wherein the at least one processor is further configured to cause the UE to receive signaling indicating the configuration.

3. The UE of claim 2, wherein the signaling comprises one or more of information corresponding to the set of data packets or a header with a value of at least one parameter corresponding to the threshold value.

4. The UE of claim 1, wherein the configuration indicates for the UE to discard an entirety of the set of data packets based at least in part on the counter satisfying the threshold value, and wherein the at least one processor is further configured to cause the UE to discard the entirety of the set of data packets based at least in part on the configuration.

5. The UE of claim 1, wherein the at least one processor is further configured to cause the UE to transmit, to a base station, signaling that indicates the data packet is discarded.

6. The UE of claim 5, wherein the signaling comprises a status report indicating a sequence number of the data packet and a numerical quantity of subsequent consecutive discarded data packets, and wherein the data packet is an initial data packet to be discarded from the set of data packets.

7. The UE of claim 5, wherein the at least one processor is further configured to cause the UE to:
initiate a prohibit timer based at least in part on transmitting the signaling; and
refrain from transmitting additional signaling that indicates an additional data packet is discarded until expiry of the prohibit timer.

8. The UE of claim 1, wherein the at least one processor is further configured to cause the UE to transmit first signaling that requests transmission of second signaling that indicates the data packet has been received.

9. The UE of claim 1, wherein the at least one processor is further configured to cause the UE to determine that the set of data packets comprises one or more redundant data packets based at least in part on the threshold value being greater than one.

10. The UE of claim 1, wherein the at least one processor is further configured to cause the UE to:
receive signaling that indicates information corresponding to the set of data packets; and
determine the threshold value based at least in part on the information corresponding to the set of data packets.

11. The UE of claim 10, wherein the information corresponding to the set of data packets comprises at least one of a forward error correction (FEC) configuration, higher layers data packetization information, FEC redundancy information within the set of data packets, or a numerical quantity of data packets corresponding to the set of data packets.

12. The UE of claim 1, wherein the threshold value is unique to the set of data packets, wherein the threshold value corresponds to at least one of a difference between a total numerical quantity of data packets in the set of data packets and a numerical quantity of source data packets in the set of data packets or a numerical quantity of redundant data packets, and wherein the set of data packets comprises one or more source data packets and one or more redundant data packets.

13. The UE of claim 1, wherein the set of data packets comprises one or more source data packets and one or more redundant data packets, and wherein the timer comprises at least one of a first duration corresponding to the one or more source data packets or a second duration different from the first duration corresponding to the one or more redundant data packets.

14. The UE of claim 1, wherein the set of data packets comprises one or more source data packets and one or more redundant data packets based at least in part on a priority level of the set of data packets, and wherein the at least one processor is further configured to cause the UE to discard the one or more redundant data packets based at least in part on the configuration indicating for the UE to discard the one or more redundant data packets.

15. The UE of claim 1, wherein the counter is reset based at least in part on receiving an initial data packet associated with the set of data packets.

16. The UE of claim 1, wherein the data packet comprises a service data unit (SDU) received from an upper layer of a protocol stack, wherein the set of data packets comprise a packet data convergence protocol (PDCP) protocol data unit (PDU) set, and wherein the timer comprises a PDCP discard timer.

17. A processor for wireless communication, comprising:
at least one controller coupled with at least one memory and configured to cause the processor to:
receive a data packet associated with a set of data packets for transmission, wherein a timer corresponding to reception of the data packet is initiated based at least in part on receiving the data packet;
increment a counter associated with the set of data packets based at least in part on a determination that the timer has expired; and
discard the data packet of the set of data packets based at least in part on the counter satisfying a threshold value and a configuration associated with the discarding of the data packet.

18. The processor of claim 17, wherein the at least one controller is further configured to cause the processor to receive signaling indicating the configuration.

19. A method performed by a user equipment (UE), the method comprising:
receiving a data packet associated with a set of data packets for transmission, wherein a timer corresponding to reception of the data packet is initiated based at least in part on receiving the data packet;
incrementing a counter associated with the set of data packets based at least in part on a determination that the timer has expired; and
discarding the data packet of the set of data packets based at least in part on the counter satisfying a threshold value and a configuration associated with the discarding of the data packet.

20. A base station for wireless communication, comprising:
at least one memory; and
at least one processor coupled with the at least one memory and configured to cause the base station to:
transmit, to a user equipment (UE), first signaling that indicates a timer associated with respective data packets in a set of data packets for transmission by the UE; and
transmit, to the UE, second signaling that indicates a configuration associated with discarding a data packet of the set of data packets based at least in part on a counter satisfying a threshold value.
